(19) United States
(12) Patent Application Publication
(10) Pub. No.: US 2004/0093242 A1
(43) Pub. Date: May 13, 2004

(54) Insurance information management system and method

(76) Inventors: Terry Cadigan, Rohnert Park, CA (US); Eugene Mannacio, Novato, CA (US); Perry Allen, Novato, CA (US); Roger Desjardins, North Andover, MA (US); David Hanson, San Rafael, CA (US); Gerri Chisholm, Novato, CA (US); Madge Grahn, San Rafael, CA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/620,429

(22) Filed: Jul. 17, 2003

Related U.S. Application Data
(63) Continuation of application No. 10/279,863, filed on Oct. 25, 2002.
Application No. 10/279,863 is a continuation of application No. 10/028,964, filed on Dec. 27, 2001, now abandoned.
(60) Provisional application No. 60/280,146, filed on Apr. 2, 2001.

(51) Int. Cl. G06F 17/60

(52) U.S. Cl. 705/4

(57) ABSTRACT

An automated system for managing insurance information is provided. The system resides on a host server and communicates with participants and providers over a network. The system includes a database for storing information and processing tools including customer service tools, claim adjudication tools, and a benefits calculation engine. The benefits calculation engine calculates an applicable benefit based on received information. The system further comprises benefit payment processing tools for paying a benefit and expense payment processing and adjustment tools. The system also includes claim reporting tools for performing reporting functions and claim management and plan loading tools for identifying a plan and updating the benefits calculation engine.

### CONTINUING DATA

This application is a continuation of U.S. patent application No. Ser. 10,279,863, filed Oct. 25, 2002, which is a continuation of U.S. patent application Ser. No. 10,028,964, filed Dec. 27, 2001, which claims the benefit of the filing date of provisional application serial No. 60/280,146, filed on Apr. 2, 2001.

### FIELD OF THE INVENTION

The invention is related to the field of insurance claims processing and insurance information management and more particularly to a method and system for automatically managing insurance information and processing claims related to a variety of insurance products.

### BACKGROUND OF THE INVENTION

Over the past few years, long term care insurance products have evolved to the benefit of both the policyholder and the insurer. Products are no longer limited to pure indemnity policies which pay a fixed amount for nursing home confinement. Instead, the policies pay on a reimbursement basis, for the care that is appropriate for the policyholders' disability. This technique lowers the cost to the insurer, while allowing more flexibility to the policyholders. The result is higher profitability and higher acceptance in the marketplace.

However, currently available claims systems were not designed for these new types of products. As a consequence, insurance companies have difficulty collecting information related to the history or the nature of the claimant's disablement or the recommended plan of care. If the insurance industry had this information readily available it would ensure payment only for those services that claimants really need. The additional disablement information would also help identify improvements to underwriting and pricing processes.

Furthermore, currently available claims systems are unable to do the more complex calculation of benefits for new reimbursement products. This makes the claims processing more manually intensive and costs the insurance industry and insurance customers unnecessary dollars. These extra costs could be avoided by a system with automated plan load and benefit calculations.

In the prior art, most existing platforms are based on non long term care products and do not contain the rules necessary to process repetitive claim situations. Typically, manual processes are used for long term care rules and workflow.

An automated system must support new products and product changes. Failure to support new products and product changes compromises the ability to provide adequate customer service, increases the possibility of overpayment, jeopardizes the ability to meet mandatory state and federal reporting requirements, makes accurate reserving more difficult, and creates the potential for pricing inaccuracies.

Therefore, a system is needed that substantially reduces or eliminates the manual effort of claims payment, benefit calculations, vendor bill reconciliation and a variety of other items. The system should further capture disablement information needed to manage the business and manage the risk. The system must capture specific services received by each claimant assessment data, plans of care, care management costs, losses by activities of daily living (ADL), and eligible facilities.

### SUMMARY OF THE INVENTION

In accordance with the purposes of the invention as embodied and broadly described herein, there is provided an automated system for managing insurance information and processing insurance claims, the system residing on a host server and comprising: capture and maintenance means for capturing and maintaining disablement information, the capture and maintenance means including a network interface and a user interface for capturing the disablement information and a database for storing the disablement information; and processing tools for processing the disablement information, the processing tools comprising a benefits calculation engine for determining benefits payable, the benefits calculation engine comprising a plurality of formulas, each formula corresponding to specific disablement information, wherein the benefits calculation engine calculates benefits for multiple reimbursement products available for multiple disablement scenarios.

In another aspect of the invention, an automated system for processing insurance claims is provided. The system resides on a host server and comprises a network interface for communicating with a client over a network; a user interface for allowing manual data entry; a database for storing insurance data, the insurance data entering the system through the network interface and the user interface; and processing tools for processing the insurance data. The processing tools comprise customer service tools including claim display means for displaying claim data, data maintenance means, correspondence tools for generating letters, and tracking means for tracking policyholders and claimants. The processing tools further comprise claim adjudication tools including means for tracking claimant data, means for tracking plans of care, means for tracking historical data by claim, and means for tracking final adjudication data; a benefits calculation engine for automatically calculating benefits payable; benefit payment processing tools including means for minimizing key entry, means for automating reimbursement claims, and means for calculating interest amounts; expense payment processing and adjustment tools including means for processing reimbursement vendor bills, means for reconciling vendor bills with services performed, means for applying payments by claim to benefit and expense accounts, means for producing expense reports, and means for allowing changes to payments; claim reporting tools for performing financial reporting, valuation, statistical analysis, partnership reporting, and experience analysis; and claim management and plan loading tools including means for instructing the system in order to properly operate the benefits calculation engine, the claim management and plan loading tools including means for identifying a plan, its coverages, and coverage limits.

In yet another aspect of the invention, a method is provided for reducing the manual effort involved in insurance claims payment, benefits calculation, and vendor bill calculation. The method comprises using an automated system for performing the steps of: capturing disablement information for adjudication, claims management, and pricing; performing automated benefits calculation for existing plans with a benefits calculation engine; providing means for loading future plan calculations and eligibility; performing statutory and internal reporting and feeds; and downloading policyholder information to set up and administer claims.

In yet an additional aspect, the invention comprises a method for automatically processing a request for insurance benefits. The method comprises receiving a benefit request; accessing captured disablement information to determine an appropriate benefit; searching for a formula that corresponds to the appropriate benefit, each formula including at least one calculation step selected from a total dollars step that generates an amount for indemnity benefits, a MAX step that limits an amount payable to a maximum, an EP step that requires an elimination period to be met prior to payment, and a PCT step that pays a fixed percentage of remaining funds; modifying an existing formula to correspond to an appropriate benefit if the appropriate benefit has no corresponding formula; and using the corresponding formula to calculate a benefit.

These and other features, objects, and advantages of the preferred embodiments will become apparent when the detailed description of the preferred embodiments is read in conjunction with the drawings attached hereto.

### BRIEF DESCRIPTION OF THE DRAWINGS

FIG. 1 is a block diagram illustrating an embodiment of the system for managing insurance information and processing insurance claims;

FIG. 2 is a block diagram illustrating processing tools for the system of FIG. 1;

FIG. 3 is a block diagram illustrating an embodiment of a client computer;

FIG. 4 is a block diagram showing interaction of the claim reporting tools with outside systems;

FIG. 5 is a flow chart showing operation of the claim management system and the claim management and plan loading tools;

FIG. 6 is an additional flow chart showing the operation of the claim management system and the claim management and plan loading tools;

FIGS. 7-13 show a user interface for allowing input for a MAX calculation;

FIGS. 14-31 show a user interface for allowing input for determining an Elimination period; and

FIGS. 32-34 show applicable variables and formats.

### DETAILED DESCRIPTION OF PREFERRED EMBODIMENTS

Reference will now be made in detail to the present preferred embodiments of the invention, examples of which are illustrated in the accompanying drawings in which like reference numerals refer to corresponding elements.

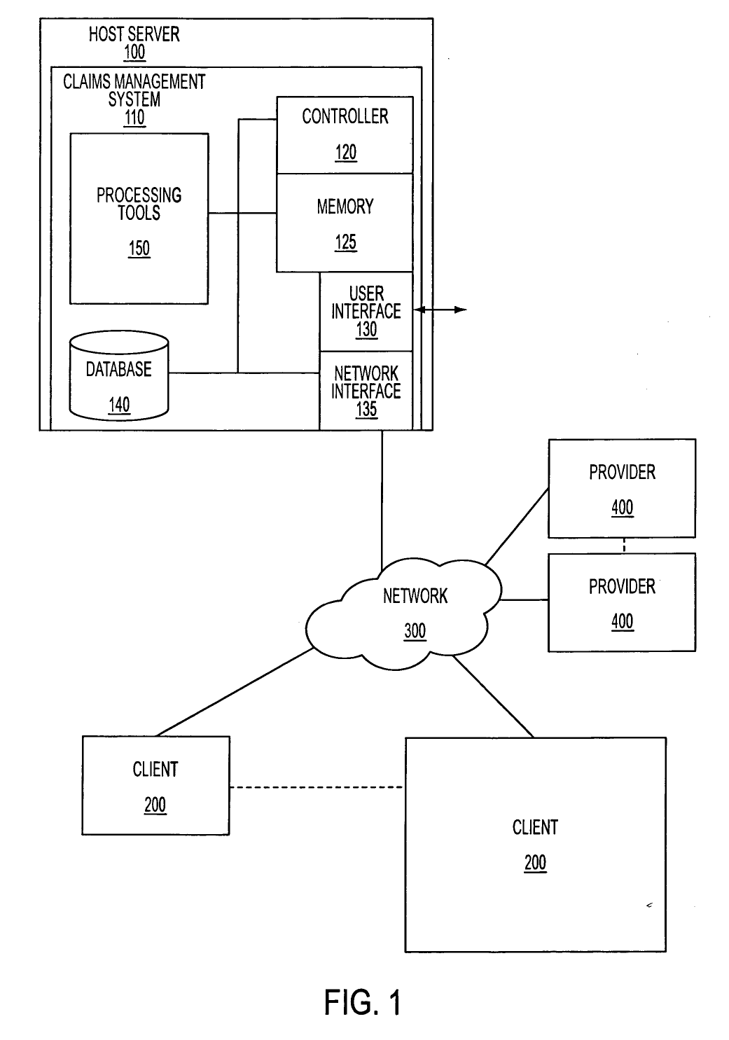

FIG. 1 is a block diagram illustrating the components of a claims management system in accordance with an embodiment of the invention. The claims management system 110 resides on a host server 100. The host server 100 communicates over a network 300 with client computers 200 and provider computers 400.

In a preferred embodiment, the host server 100 is a VB6 or MS SQL Server that will integrate multiple previously existing functions into one system. The host server 100 may be or include, for instance, a workstation running the Microsoft Windows™ NT™, Windows™2000, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform.

The claims management system 110 includes a controller 120, a memory 125, a user interface 130, a network interface 135, a database 140, and processing tools 150. The claims management system 110 communicates over a network 300 through the network interface 135 with the client computers 200 and the provider computers 400.

The controller 120 may include a microprocessor such as an Intel x86-based device, a Motorola 68K or PowerPC™ device, a MIPS, Hewlett-Packard Precision™, or Digital Equipment Corp. Alpha™ RISC processor, a microcontroller or other general or special purpose device operating under programmed control.

The memory 125 may include electronic memory such as RAM (random access memory) or EPROM (electronically programmable read only memory), storage such as a harddrive, CDROM or rewritable CDROM or other magnetic, optical or other media, and other associated components connected over an electronic bus, as will be appreciated by persons skilled in the art.

The network interface 135 may be or include a network-enabled appliance such as a WebTV™ unit, radio-enabled Palm™ Pilot or similar unit, a browser-equipped cellular telephone, or other TCP/IP client or other device.

The database 140 may be, include or interface to, for example, the Oracle™ relational database sold commercially by Oracle Corp. Other databases, such as Informix™, DB2 (Database 2), Sybase or other data storage or query formats, platforms or resources such as OLAP (On Line Analytical Processing), SQL (Standard Query Language), a storage area network (SAN), Microsoft Access or others may also be used, incorporated or accessed in the invention.

The network 300 preferably comprises the Internet and the clients 200, the providers 400, and the host server 100 may communicate with the network 300 in any well known manner. The communications links may be, include or interface to any one or more of, for instance, the Internet, an intranet, a PAN (Personal Area Network), a LAN (Local Area Network), a WAN (Wide Area Network) or a MAN (Metropolitan Area Network), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. The communications link may furthermore be, include or interface to any one or more of a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, a Bluetooth radio link, or an IEEE 802.11-based radio frequency link. Communication may also be accomplished by any one or more of an RS-232 serial connection, an IEEE-1394 (Firewire) connection, a Fibre Channel connection, an IrDA (infrared) port, a SCSI (Small Computer Systems Interface) connection, a USB (Universal Serial Bus) connection or other wired or wireless, digital or analog interface or connection.

An embodiment of the client 200 is shown in FIG. 3. The displayed embodiment includes a controller 202, a user interface device 204 such as a mouse, monitor, or keypad, a network interface 206, a processor 208, and a memory 210. The client 200 may take any known form, such as a personal computer running the Microsoft Windows™95, 98, Millenium™, NT™, or 2000, WindowsTMCE™, PalmOS™, Unix, Linux, Solaris™, OS/2™, BeOS™, MacOS™ or other operating system or platform. The various components may be substantially similar to those described above with reference to the host server 100. Provider computers 400 may have any conventional structure, but preferably are substantially similar to the client computers 200 described above.

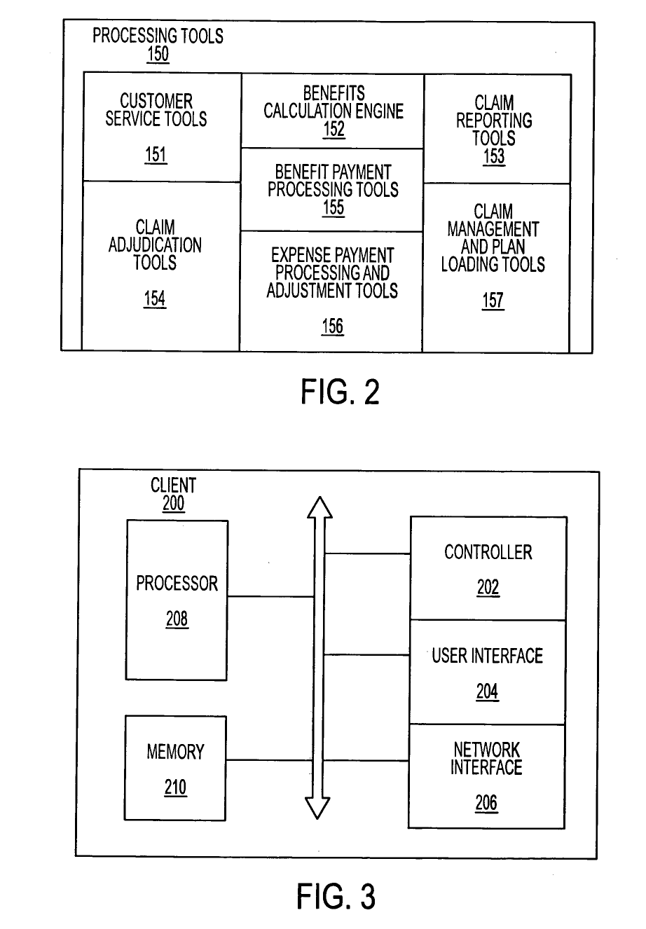

FIG. 2 illustrates the details of the processing tools 150 resident on the host server 100. The processing tools 150 include customer service tools 151, a benefits calculation engine 152, claim reporting tools 153, claim adjudication tools 154, benefit payment processing tools 155, expense payment processing and adjustment tools 156, and claim management and plan loading tools 157.

The customer service tools 151 work in conjunction with the database 140 to perform data maintenance tasks. The customer service tools 151 collect data from clients or plan participants 200 such as personal and license data and claim history. The customer service tools 151 also collect provider data such as POA, facility data, and key contacts. All of the aforementioned data is maintained in the database 140. The customer service tools 151 also collect administrative changes to closed claims, mailing and residence addresses, and confinement calls. By retrieving the collected data from the database 140, the customer service tools 151 perform such functions as tracking claim stages, performing historical tracking for each participant, making administrative changes to closed claims, and providing an on-line history of waiver status.

The customer service tools 151, when accessed either through the user interface 130 or the network interface 135 can conduct a client search through the use of collected personal data such as first and last name, social security number and tax ID number, and policy number. The customer service tools 151 can also conduct a claims inquiry and can provide an on-line view of expense and benefit payments.

A further function of the customer service tools 151 is to provide for correspondence such as routine and ad-hoc letters, multi-page letters on letterheads varying by company name for all varieties of correspondents including claimants, agents, providers, etc. The customer service tools 151 further provide system-generated letters that are time or event triggered and letter generation to acknowledge receipt of phone call or correspondence.

Customer service tools 151 perform a tracking function including tracking of policyholders who wish to submit a claim. The tracking function tracks such paramaters as date of notification received, date claim packet was mailed, and system generated reminders to submit claim.

The customer service tools 151 perform facility inquiries and can automatically generate a facility inquiry form using care provider information stored in the database 140. If a facility license has expired, the customer service tools 151 issue a warning.

The customer service tools 151 also set up new customer claims by showing all data regarding insured's allowable coverages on single screen. The new claim setup can indicate such items as missing claim documents, potential future benefit eligibility, and lack of required information. The client can use the customer service tools 151 for updating of insured's coverage and premium data in certain cases, viewing complete policy contract language, and automatic generation of an acknowledgement letter.

The claim adjudication tools 154 track claimant data. In order to adequately adjudicate claims, claimant data includes personal data such as name, gender, address, SSN, etc., at least 3 diagnoses, including the original and most recent, up to 10 ADLs by date of loss, and claim result of sickness and injury. The claim adjudication tools further comprise means for tracking plans of care, requiring data such as type and frequency of service, service providers, number of hours, services are provided, and any additional info for providers and services.

The claim adjudication tools 154 additionally include means for tracking additional requirements of reimbursement claims such as: on-site assessor, contact, and vendor, and a facility for tracking intake data. The claim adjudication tools 154 further include means for tracking historical data by claim. In order to perform this function, the claim adjudication tools have access to data including plan of care, dates and scores of three most recent assessment tools SPMSP, and level of assistance required, which is matched to ADLs. The claim adjudication tools 154 further include means for tracking financial adjudication data. Data required for tracking include: user defined close identifiers; change of status for further payments on closed claims; all claim termination data elements; auto-calculated benefit cease date; and automated claim-close letter.

Expense payment and adjustment tools 156 are preferably capable of performing long term care (LTC) payment adjustments. The expense payment and adjustment tools 156 include means for processing reimbursement vendor bills, means for separating benefits from expenses, means for supporting electronic data interchange (EDI), means for receiving assessment data from vendors, and means for remitting fees to a vendor as a single transaction for multiple claims. Expense payment and adjustment tools 156 additionally include means for reconciling vendor bills with services performed, means for applying payments by claim to benefit and expense accounts, and means for producing various expense reports under different expense categories.

Expense payment and adjustment tools 156 further include means for making LTC payment adjustments by allowing for changes to payments after set-up. The expense payment and adjustment tools 156 include means for handling of voided checks and returned checks, means for allowing benefit payments to be canceled and associated checks voided, means for allowing for return of monies by claimant and matching to benefit/payment being recovered, and means for allowing for re-releasing a payment on a closed claim.

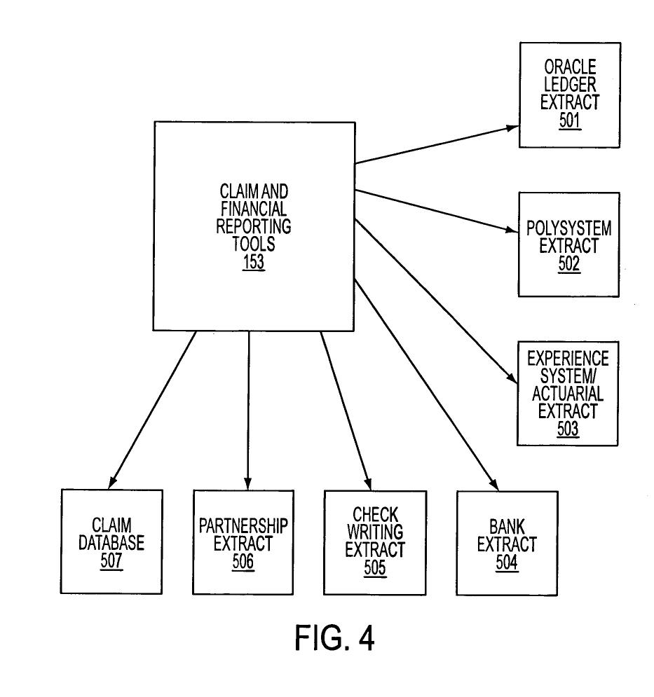

The claim and financial reporting tools 153 include means for performing financial reporting, claim valuation, statistical analysis, partnership reporting, experience analysis, bank reconciliation, and check writing. The claim and financial reporting tools 153 further include claim reporting means for reporting claim data to a claims database 507. FIG. 4 shows the proposed reporting data flow.

In the proposed financial reporting scenario, the claims management system 110 collects data and sends it to the database 140. The claim and financial reporting tools 153 then extract and report the data to an Oracle ledger extract 501. The reported data includes: company, channel, statutory line, product, resident state, applicable state, policy form, loss date, and paid date. Sufficient data must be collected to output claims paid and expenses.

For the valuation process, the claims management system 110 collects the data, sends the data to a polysystems extract 502 where valuation occurs and subsequently valuation reports are generated. The data includes loss date, diagnosis code, and benefit code. The output includes case reserves and estimate of future payments on known claims.

The claim and financial reporting tools 153 also perform statistical reporting. The proposed data flow is from the claims management system to an actuarial extract 503 to weekly reports. The transferred data include status, status effective date, and close reason. The output includes a number of new, approved, denied, and closed claims, and amount of new reserves, closed reserves, and anniversary changes.

The claim and financial reporting tools 153 further include means for performing partnership reporting functions. The proposed data flow is directly from the claim and financial reporting tools 153 of the claims management system 110 to a quarterly partnership extract 506. The claim and financial reporting tools 153 process data including claimant data, assessment data, service codes, loss date, and decision date. The claim and financial reporting tools 153 operate to provide output including amount paid, number of payments, number of days of service, and benefits paid by other insurers.

The claim and financial reporting tools 153 further include means for reporting experience analysis. The proposed data flow is from the claims management system 110 to an actuarial extract or an experience system 503. The reported data includes loss date, diagnostic code, benefit code, and assessment data. The output includes actual claim cost and expense.

The claim and financial reporting tools 153 further include bank reconciliation means in which payment data is reported to a bank extract 504 and check writing means in which payment data is forwarded to a check writing extract 505.

In summary, as shown in FIG. 4, the claims management system 110 obtains the above-identified information and feeds it to an Oracle ledger extract 501, a polysystem extract 502, an experience system/actuarial extract 503, a bank extract 504, a check writing extract 505, a partnership extract 506, and an external claim database 507. This feeding system improves the external claim database, drill down capabilities, standard reports, flexible reports, data retention, and audit trail.

The claim management and plan loading tools 157 make the claim management system simple to use. The claim management and plan loading tools 156 include means for allowing a user to sign on using a network ID, and a manager facility to set or reset benefit and expense limits (individual and aggregate). The claim management and plan loading tools 156 also allow an authorized user to release payments over a predetermined limit, create and change status codes, identify if status allows payment, create new users or change privileges, and modify policy data such as MSB. The claim management system 110 further sets agreed upon response times and hours.

With respect to the plan loading aspect of the claim management and plan loading tools 157, the authorized user must be able to give the claims management system 110 the claims calculation rules are for any new product so that the claims management system 110 will be able to update the benefits calculation engine 152 in order to determine an amount for payment.

In order to determine the correct payment amount, the benefits calculation engine 152 needs the plan code that identifies the plan, what coverages (table/series) the plan includes, whether each of these coverages is indemnity or reimbursement, and where to find coverage limits such as EP and deductibles. Once coverage limits are known, the claims management system 110 also must be instructed as to how limits are used (e.g. EP is continuous, daily/weekly max). Additional required information includes whether the coverage includes BIO and how BIO is applied to the limits. Furthermore, the claims management system 110 must be told what benefits by code are paid under each coverage, any special limits that apply to benefits (e.g. equipment), how many payments by medicare or other carriers are considered, the percentage of allowable expenses to reimburse, and whether the plan of care affects this percentage or any limits.

In addition to the payment amount, the claims management system 110 also needs to know when to pay the amount. Information required to determine timing of payments includes: (1) what ADLs are in the plan and how many are needed for eligibility; (2) what other factors such as cognitive impairment are considered; and (3) what services have been authorized under the plan of care. Additional information which facilitates the operation for the claims management and plan loading tools 157 includes identification of partnership products and the level of detail with which these products must be tracked.

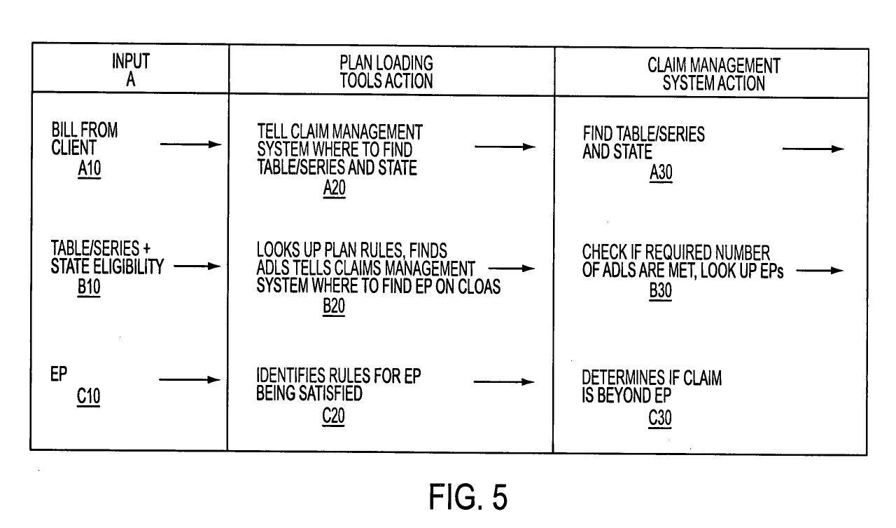

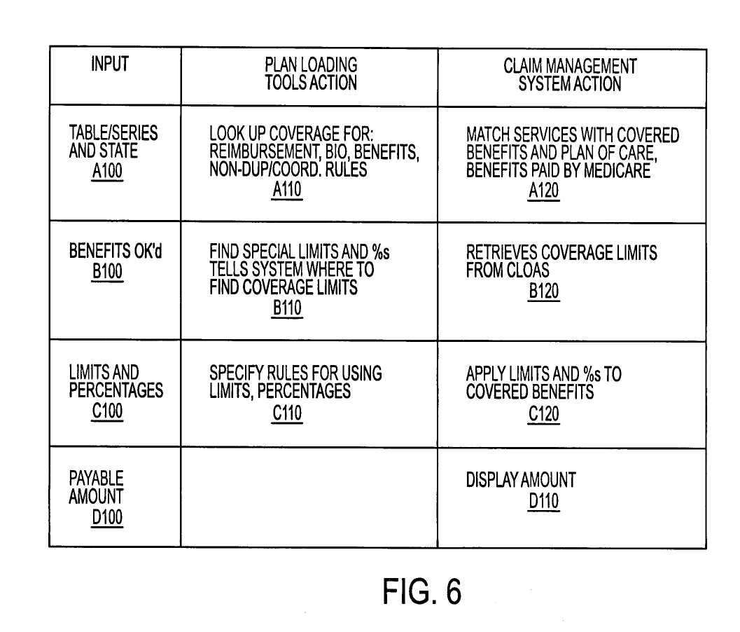

FIG. 5 is a chart illustrating the flow of input information between the claims management and plan loading tools 157 and other portions of the claims management system 100. Upon receiving an input client bill in step A10, the claim management and plan loading tools 157 tell the claims management system 110 where to find the Table/series and state, and in step B10, the claim management system 110 inputs this information to the claim management and plan loading tools 157. In step B20, the claim management and plan loading tools 157 look up plan rules, find ADLS, and tell the claims management system 110 where to find EP. In step B30, the claims management system 110 inputs the EP to the claims management and plan loading tools 57, which identify the rules for the EP being satisfied in step C20. In step C30, the claims management system 100 determine if the claim is beyond EP. FIG. 6 is a flow chart showing additional operations of the claims management system 100 and claim management and plan loading tools 157. Upon receiving the table/series and state as input in step A100, the claim management and plan loading tools 157 look up coverage for information regarding reimbursement, BIO, benefits, and rules in step A 110. In step A120, the claims management system 110 matches services with covered benefits and plans of care and benefits paid by Medicaid. In step B100, the claims management system 110 sends the approved benefits to the plan loading tools 157. In step B110, the plan loading tools 157 find special limits and percentages and tell the claims management system 110 where to find coverage limits. In step B120, the claims management system 110 retrieves coverage limits and percentages from CLOAS. In step C100, the claims management system 110 inputs the limits and percentages to the plan loading tools 157. In step C110, the claim management and plan loading tools 157 specify rules for using the limits and percentages. In step C120, the claim management system 110 applies limits and percentages to covered benefits and inputs the payable amount to the claim management and plan loading tools 157 in step D100. Finally, in step D110, the claims management system 110 displays the benefit amount.

The benefit payment processing tools 155 make payments to insureds, beneficiaries, vendors, and others. The benefit payment processing tools 155 allow for EFT of benefit and expense payments. The benefit payment processing tools 155 perform such functions as: indicating how many copies of checks are needed to process payments for ongoing benefit periods under single claim number; processing payments under different lines of coverage on the same claim; generating EOBs automatically; storing benefit and expense data; identifying claim payment by company, state market, state line and benefit or expense code; allocating benefits by benefit code, policy form, type of facility, etc.; and requiring management approval of payments that exceed dollar authority limits.

The benefit payment processing tools 155 minimize key entry by defaulting to next payable period dates, defaulting benefit payment to the last payee, and excluding days from payment. The benefit payment processing tools 155 automate reimbursement claims by storing relevant billing statement data and calculations, tracking bills and linking to payments, capturing payments from medicare and other providers, retrieving co-payment amount and deductibles, and calculating net payments.

The benefit payment processing tools 155 also log and track confinement calls at benefit set-up and calculate interest amounts. With respect to interest amounts, the benefit payment processing tools 155 add the interest calculated to the benefit amount or pay the interest amount separately and warn processors that interest may be due soon if no payment has been made. The benefit payment processing tools 155 allow for splitting and combining of benefit payments.

An additional processing tool 150 is the benefits calculation engine 152, which automatically calculates benefits payable and is capable of limiting benefit payments to coverage maximums, calculating the elimination period and deductible in days and dollars respectively. The benefits calculation engine 152 consults with the database 140 to support varying benefit percentage rates. For reimbursement products, the benefits calculation engine 152 supports actual amounts charged. The benefits calculation engine 152 also supports a prevailing expenses table, and nonduplication of coverage calculations.

The benefits calculation engine 152 determines how much of a benefit to pay based on rules provided in formulas stored in the database 140. Each available product has a benefit code which uses a formula to calculate benefits.

Each formula stored in the database 140 includes sections containing steps. Simple formulas may have only one main section. Complex benefits contracts pay differently based on condition. Therefore, formulas for calculating these benefits have more than one section. Each section has multiple steps which may include both calculation steps and traffic regulating steps.

Traffic regulating steps are conditions that determine when to run which formula section. The traffic regulating steps includes four parameters. The first is a condition that is evaluated as being true or false. The condition includes: a field selected from a list of database fields; one of five operators <=, <, =, >, and =>; a fixed value to which the field is compared. Secondly, the traffic regulating step includes the section or next step to perform if the condition is true. Third, the traffic regulating step includes a default condition to be executed if a database record is not found. Finally, the traffic regulating step includes a standard query language (SQL) expression for conditions that are too complex to be created by the above device.

The other major category of steps is the calculation steps. There are multiple types of calculation steps, including: 1) a total dollars step, which generates an indemnity benefits amount; 2) a maximum (MAX) step, which limits the amount paid to a maximum; 3) an elimination period (EP) step which requires an elimination period to be met before paying; and 4) a percentage (PCT) step which pays a fixed percentage of a remaining amount.

Every calculation step except the total dollars step takes the calculated amount from the previous step, performs calculations and alters the result, and passes the result to next step. The total dollars step must be the first step or section.

The formulas use several different kinds of maximums and elimination periods. The steps have parameters to account for this variation. The following discussion examines the parameters for each step and explains their purpose and how they work. For the MAX step, maximums can be daily, weekly, monthly, lifetime. This limitation on a maximum suggests a temporal parameter (PER). The maximums can be on the policy, coverage, or just the benefit. These are scope parameters which restrict the maximum based on “type”. The maximums can limit dollars, days, or services. Dollars, days, and services are known as “units”.

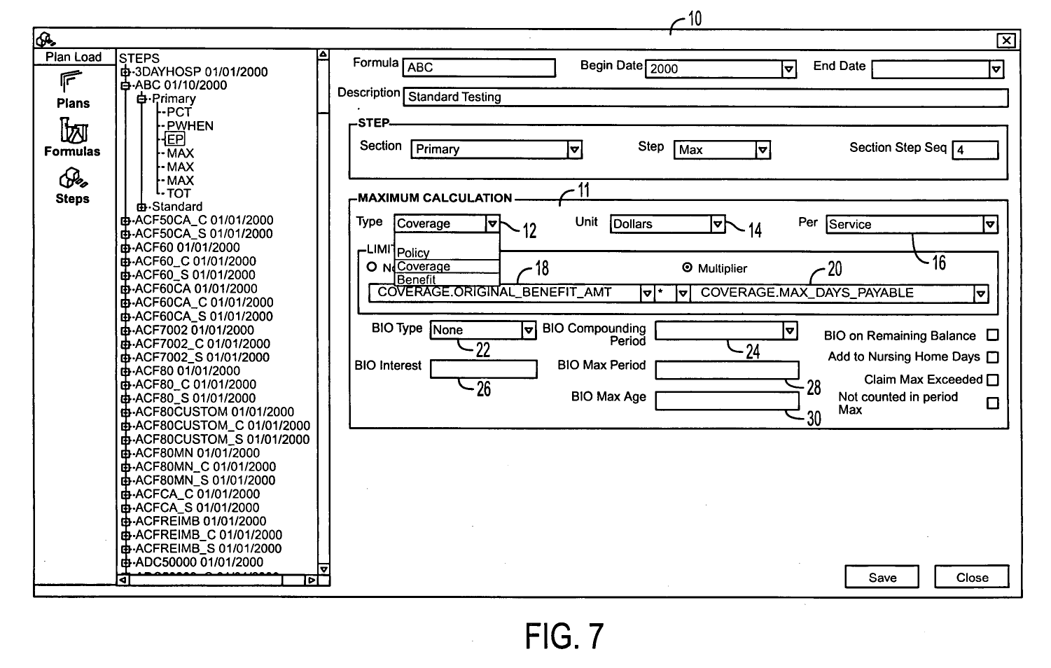

As shown in FIGS. 7-13, a user interface allows calculation of a maximum based on selection of the aforementioned parameters. FIG. 7 shows a user interface 10 for selecting parameters to perform a MAX calculation in the MAX calculation box 11. Selection of the type parameter 12 is shown in FIG. 7. As shown, the user may select the type parameter 12 as one of coverage, benefit, and policy.

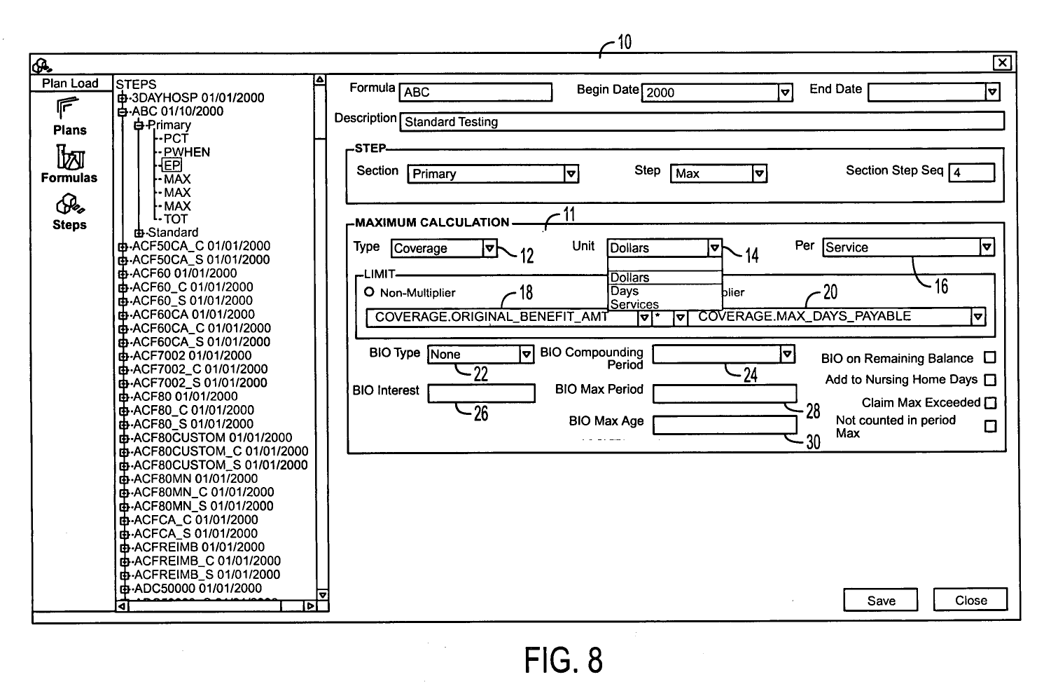

FIG. 8 shows the selection of the units parameter 14 in connection with the MAX calculation. As shown, the units parameter may be selected as one of dollars, days, or services.

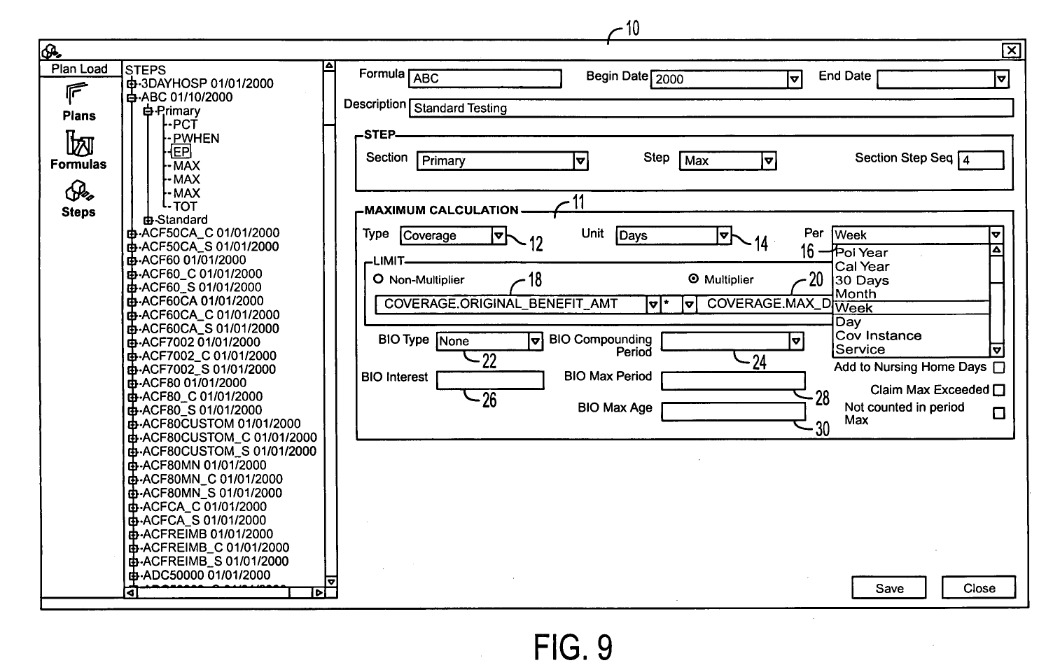

FIG. 9 shows the selection of the PER parameter 16 for the MAX calculation. The PER parameter 16 may be one of policy year, calendar year, 30 days, one month, one week, one day, covered instance, or service. Other PER parameters may also be entered into the system.

Every maximum must have a limit. Several different varieties of limits are possible. Inside limits are fixed and written into the contract. An advantage of inside limits is the simplicity of entering a constant. Outside limits are selected by the policy holder and part of the benefits schedule page. With outside limits, selection must be accomplished by referencing a database field. A weekly maximum can be calculated as the product of a field and a constant. A product of two fields is a lifetime maximum.

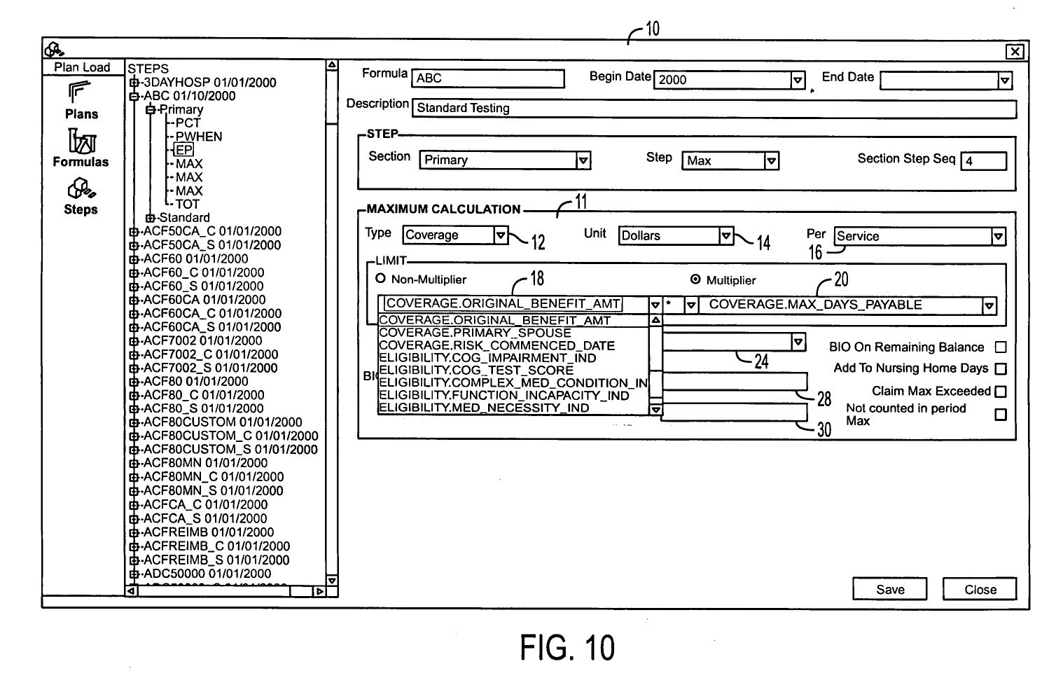

FIG. 10 shows the selection of the LIMIT parameter 18 for the MAX calculation on the user interface 10. The limit parameter reflects coverage limitations such as limitations to the original benefit amount, limitations on person covered, and limitations on conditions covered. Other limitations may be entered as necessary.

The aforementioned parameters are the primary parameters for the MAX calculation and handle most common cases. However, some cases require additional parameters. For instance, BIO adjustments may be required on the remaining balance. In this instance, a checkbox parameter 32 is provided. Additionally, benefits such as equipment that pay many times the daily MAX and should not be included in a periodic MAX. Furthermore, when there is also a lifetime coverage maximum, expressed in days, benefits contribute days equal to the benefit divided by the daily MAX. Furthermore, for nursing home days, the system may need to set an accumulator field to identify days of respite care available. The maximum step may set a flag under circumstances in which a claim MAX has been exceeded. Once set, these values can be used by the traffic regulating step.

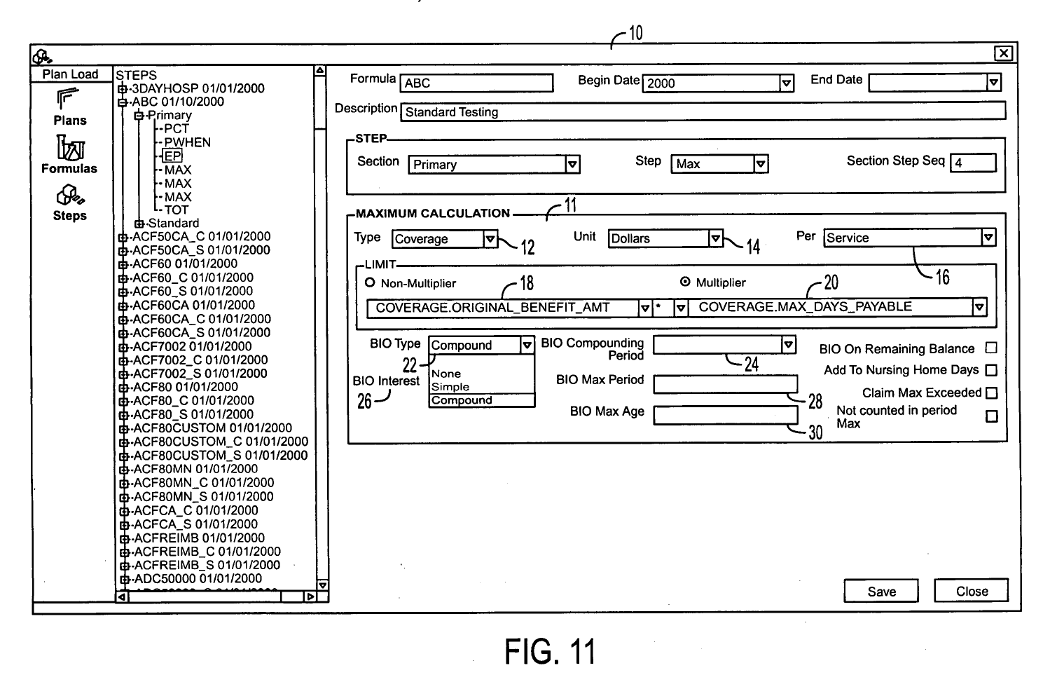

FIG. 11 shows the selection of the BIO Type parameter 22 for the MAX calculation. Selectable options include compound, simple, and none. Other BIO parameters include BIO interest rate 26, BIO compounding period 24, BIO MAX period 28, and BIO MAX age 30.

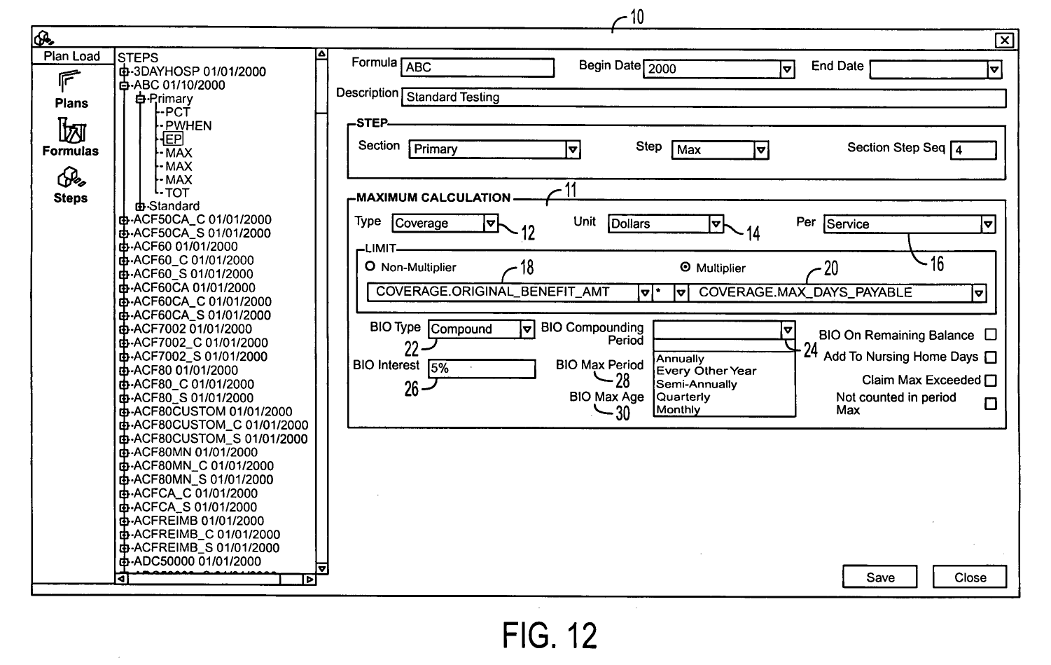

FIG. 12 shows the selection of the BIO compounding period 24 in connection with the MAX calculation. The BIO type 22 has been selected as compound and the BIO interest 26 has been selected as 5%. Selectable BIO compound period variables 24 include annually, every other year, semi-annually, quarterly, and monthly. Other periods may also be entered if necessary.

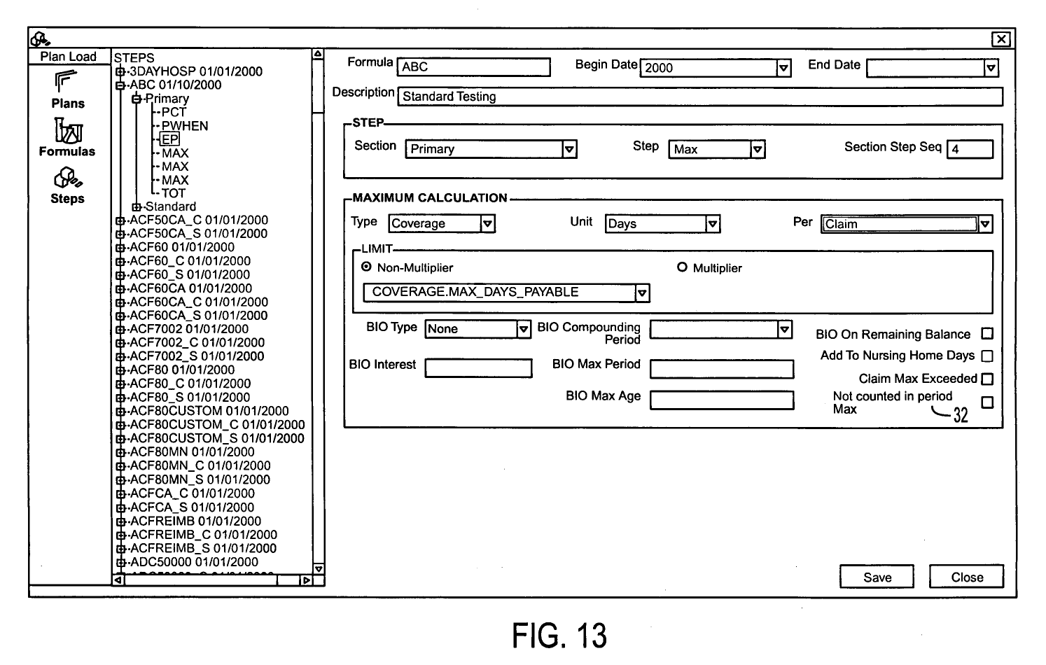

FIG. 13 displays a user interface for selecting other parameters for the MAX calculation. Other parameters may include parameters 32 such as “add to nursing home days”, “BIO on Remaining Balance”, “claim MAX exceeded”, and “not carried in period MAX”.

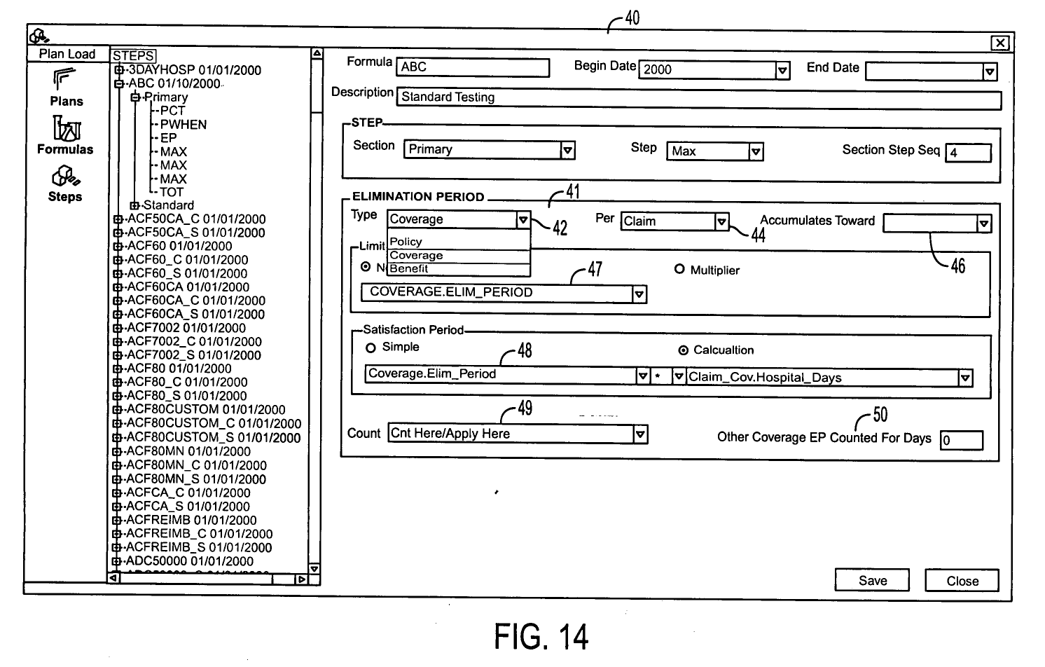

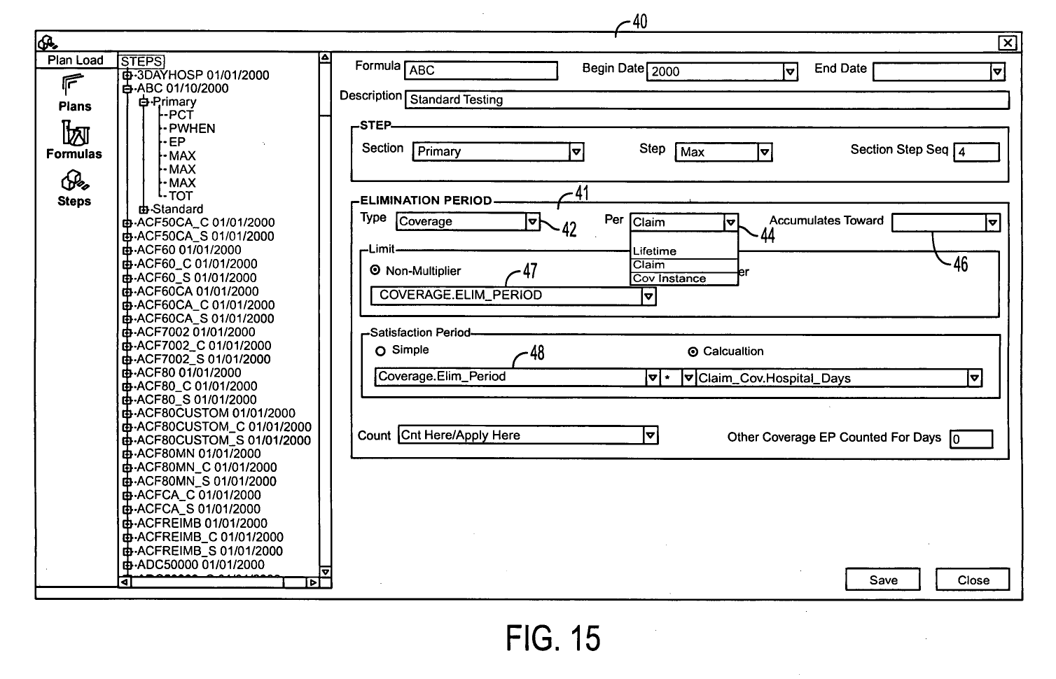

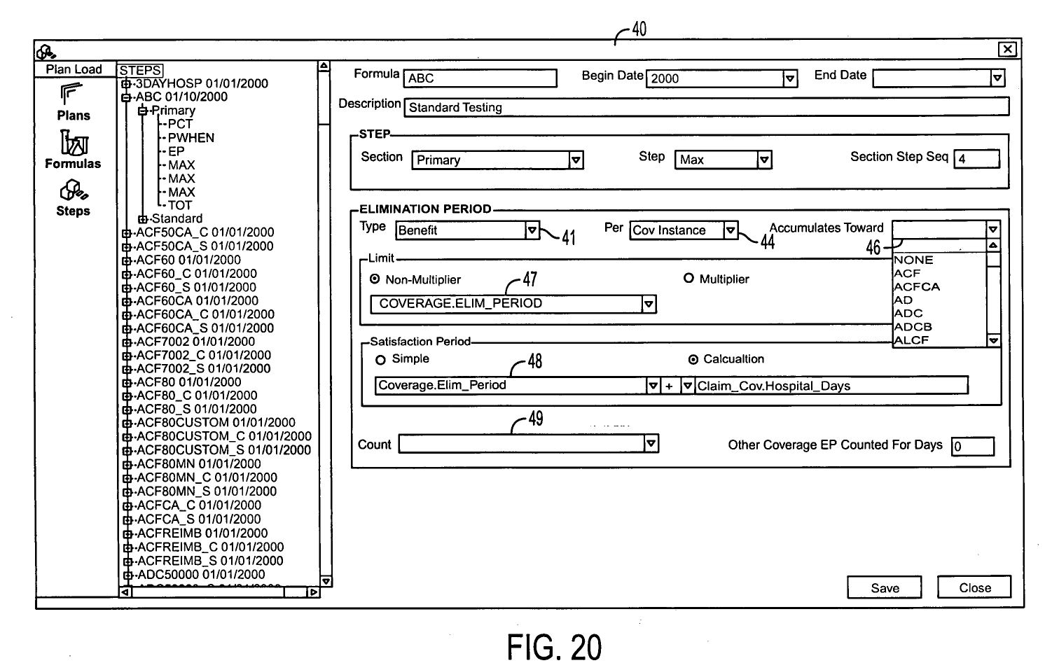

FIGS. 14-21 show a user interface for allowing input for determining an elimination period. Elimination period (EP) parameters suggest themselves naturally. EPs may be at policy, coverage, or benefit level. As shown in FIG. 14, “type” parameter 41 represents this scope of EP benefit. EPs may need to be satisfied on every claim, after any interruption in service, or just once in a lifetime. The PER parameter 44, as shown in FIG. 15, is used to show how often the EP must be satisfied.

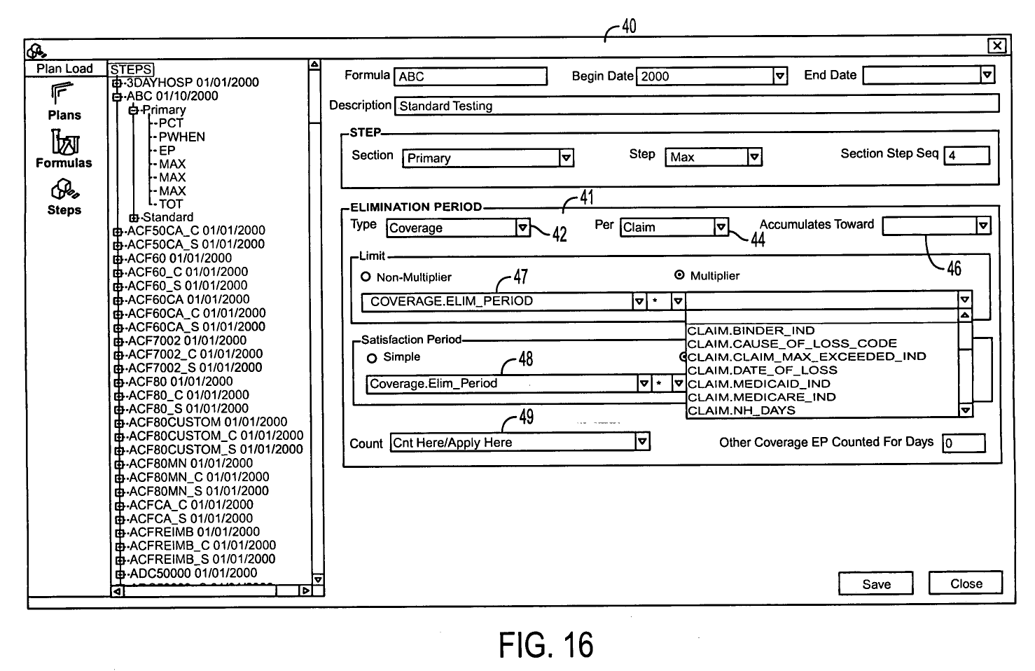

EP also has a limit. As shown in FIG. 16, as with MAX, the limit can be inside or outside limit. Accordingly, the user interface entry screen as shown in FIG. 16 offers the same options as the MAX user interface entry screen.

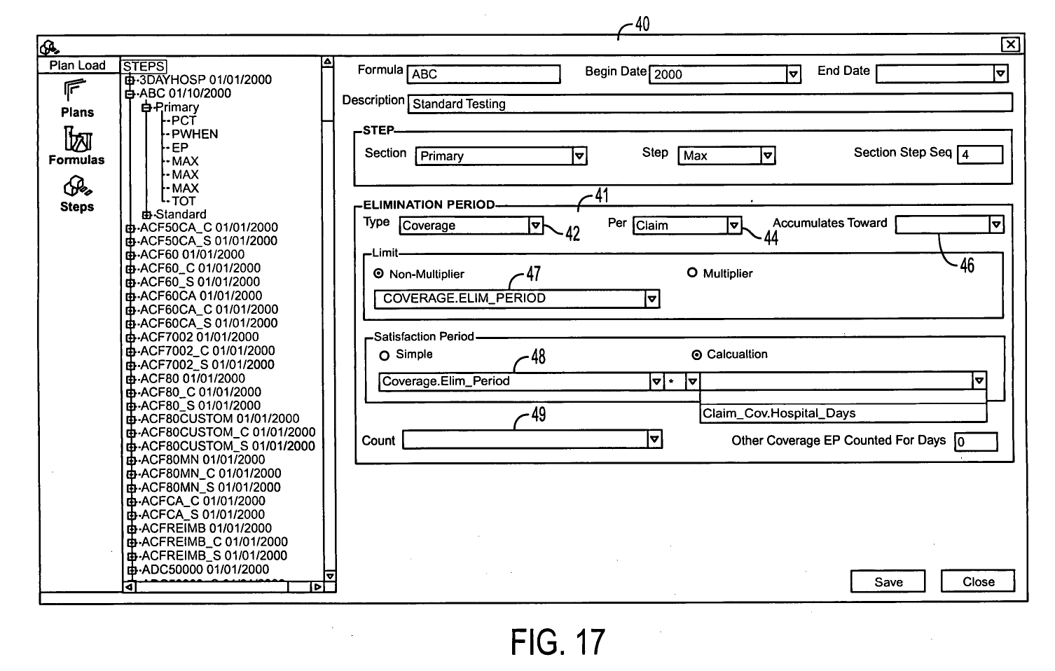

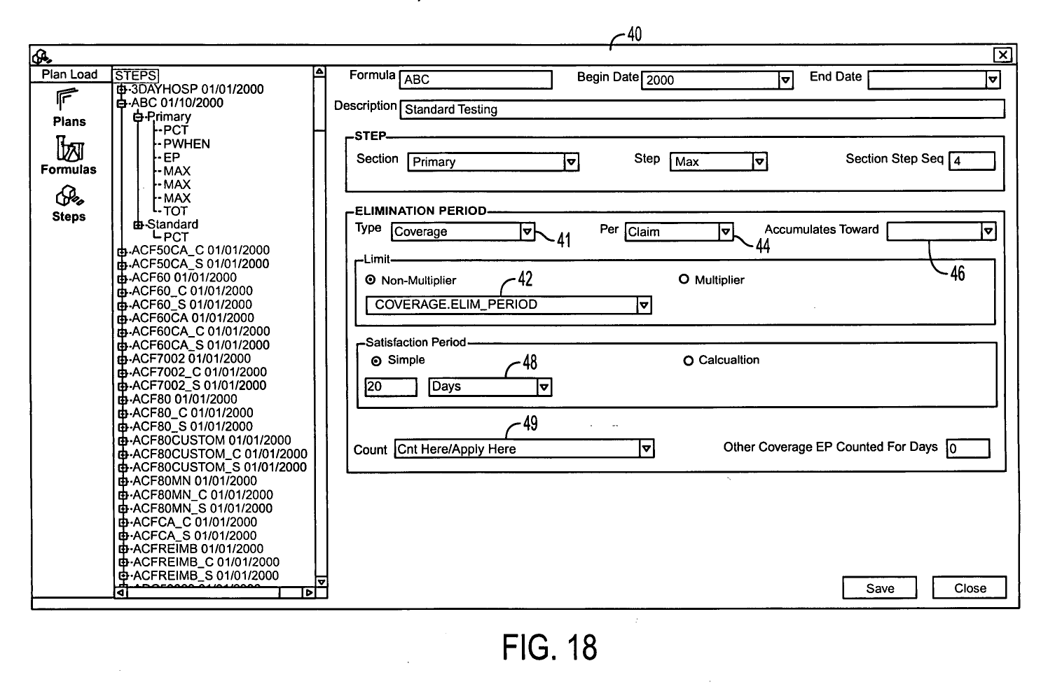

EPs are not all uninterrupted. Some EPs can be satisfied in three times the limit, some may allow interruption only for hospital visits and some may run for a fixed time period. As shown in FIGS. 17 and 18, a parameter called the satisfaction period takes this into account.

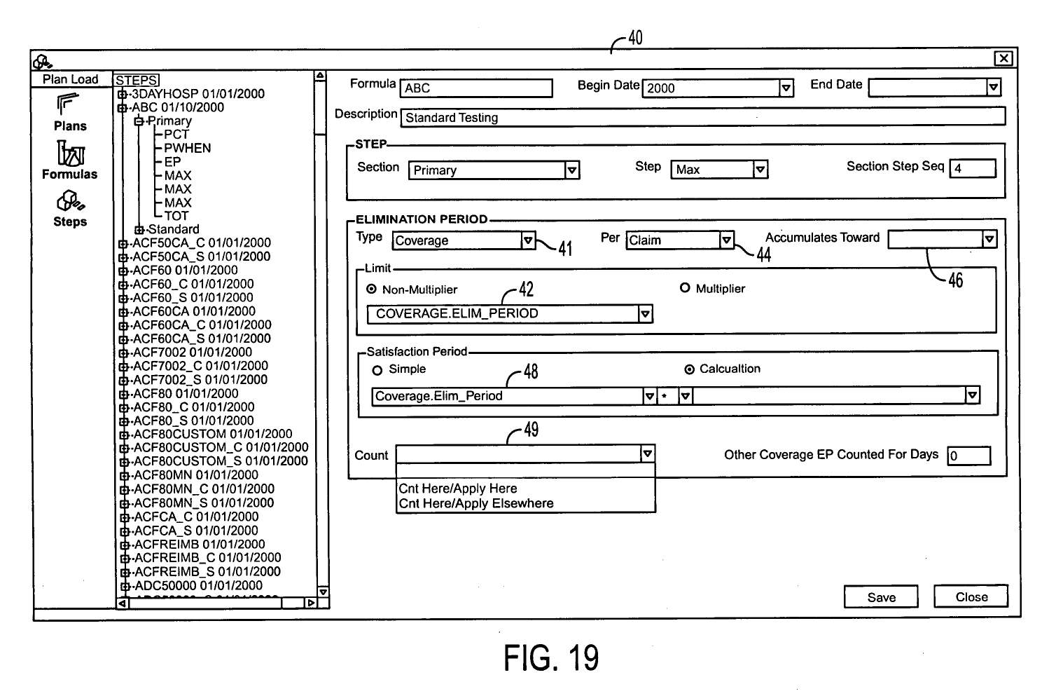

Certain benefits contribute to EP but are not subject to it. As shown in FIG. 19, count parameter 49 called “count here/apply elsewhere” handles this situation. “Elsewhere” means elsewhere in the coverage or policy. Normally, the applicable parameter is “count here/apply here”. For benefits EP, the user identifies a benefit or benefit code where the days apply. Using the current benefit code instructs the system to “count here/apply here” and using none would instruct the system to “apply here/don't count here”.

For a benefit type to apply elsewhere, the user must specify where. The user can make this specification through the use of the “accumulates toward” parameter.

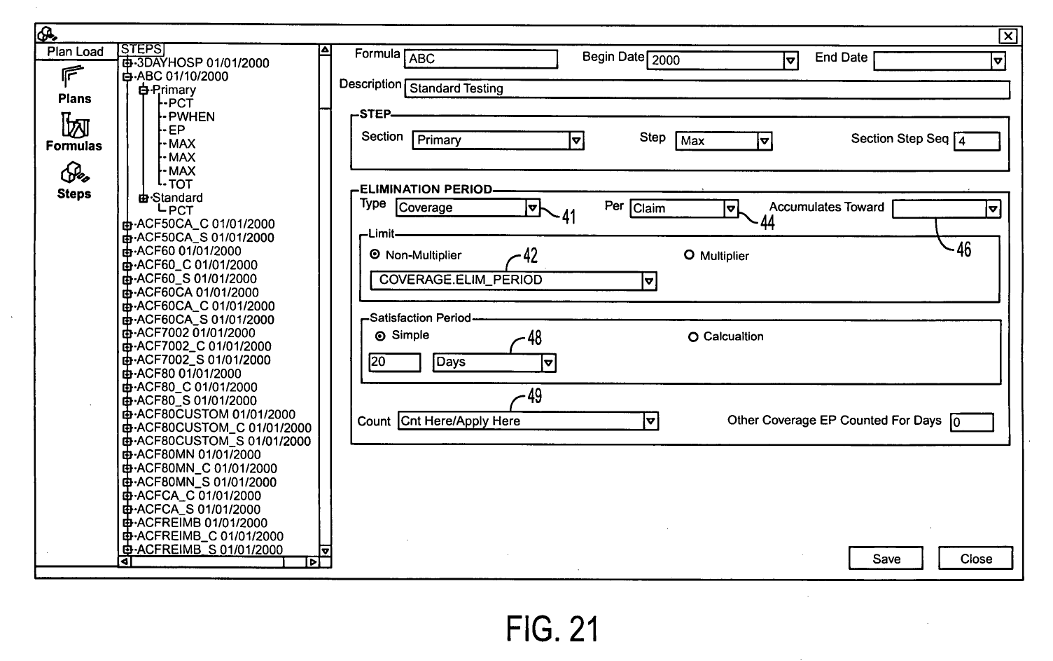

One series of policies has a provision in which one coverage of EP days can be used to satisfy other coverages (for period of 90 days). As shown in FIG. 21, a specialized parameter “Other coverage EP counted for” 50 is employed under this circumstance.

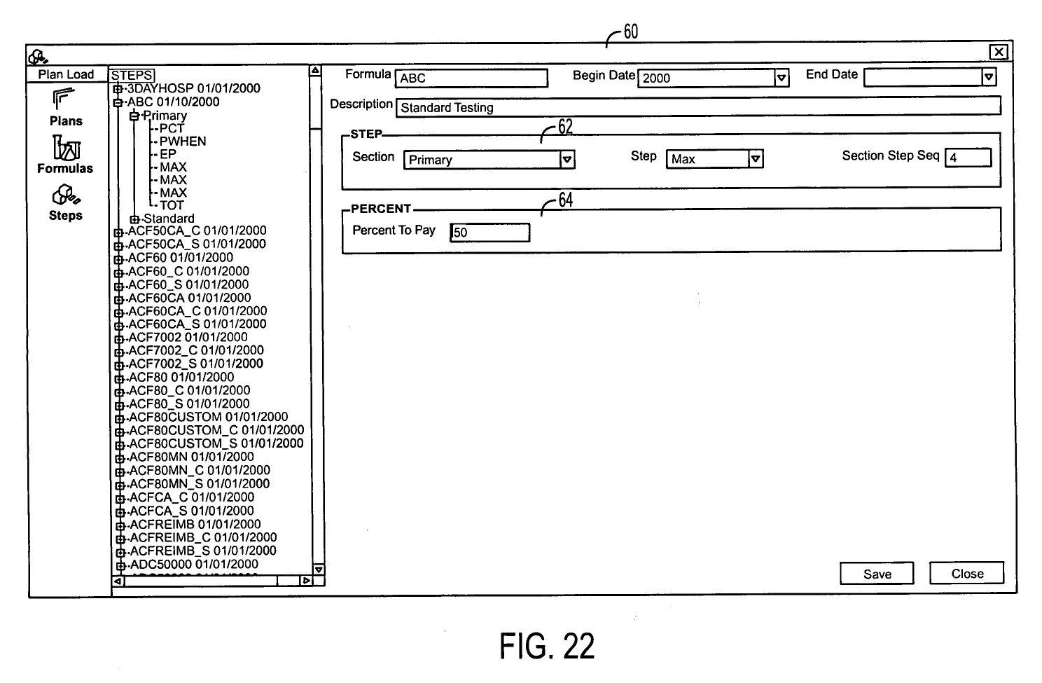

FIG. 22 shows the user interface 60 for the percentage (PCT) formula, which is necessary since insurance providers don't always pay 100% of every benefit. The user interface screen 60 includes a step selection area 62 and a percentage selection area 64.

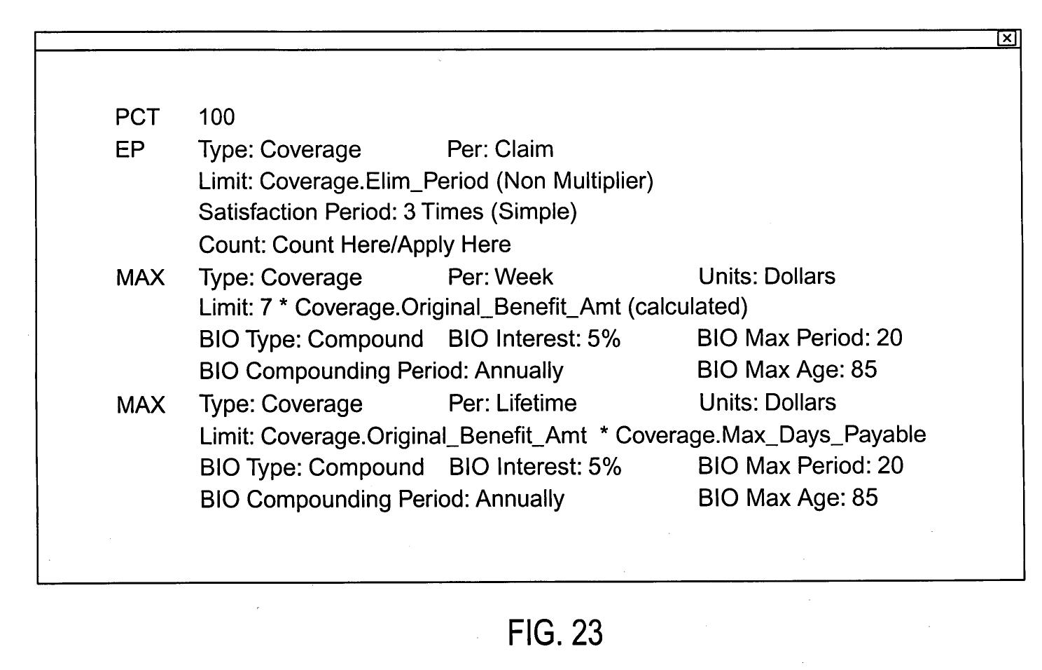

The Total Dollars, EP, PCT, and MAX steps are sufficient to construct simple reimbursement formulas to be implemented by the benefits calculation engine 152. For example, in a Home Health Care (HHC) scenario, suppose that: (1) HHC pays a maximum each week of 7 times the selected daily maximum after EP is applied to each claim and for all benefits under the coverage; (2) the claimant has 3 times the EP limit to satisfy the EP; (3) during policy holder's life, the policy pays no more than amount equal to a MAX number of days multiplied by the daily maximum; (4) the plan has a compound BIO terminating at age 85 or after 20 years; and (5) BIO is compounded annually at a rate of 5%. These conditions are set forth in the shown in FIG. 23.

In order to allow overrides, the benefits calculation engine 152 must provide a PCT step even when PCT=100%. The PCT step normally occurs prior to the MAX step because MAX benefits are based on what is paid, not what was billed. For the same reason, the benefits calculation engine 152 generally performs EP steps before MAX steps. A period MAX applies prior to a lifetime MAX because the lifetime MAX is based on payments after the application of the period MAX.

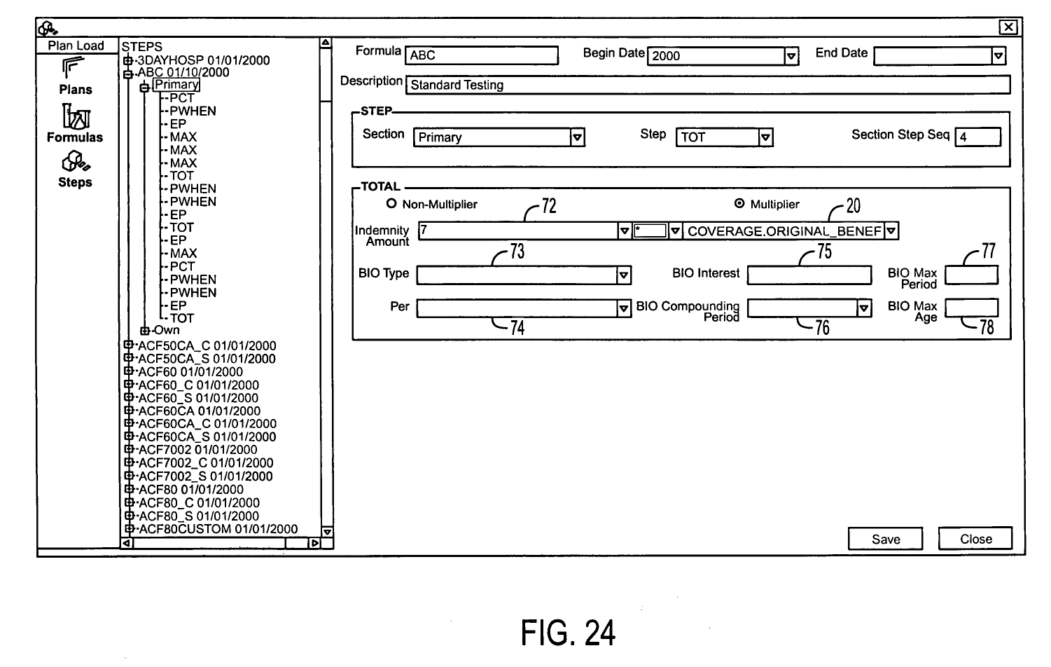

Indemnity formulas use a total dollar step. The total dollar step user interface screen 70 is shown in FIG. 24. Unlike any other step type, the total dollar calculation step generates its own output and takes no input from other steps. Therefore, the total dollar step must be first calculation step, but can come after the traffic regulating step. The total dollar step is similar to a MAX step that is always returning the maximum rather than limiting the input amount to the maximum. Consequently, the parameters and design for the total dollar step are similar to those of the MAX step. As shown in FIG. 24, an indemnity amount parameter is entered for total dollars, much like limit 72 is for max, but without a calculation option.

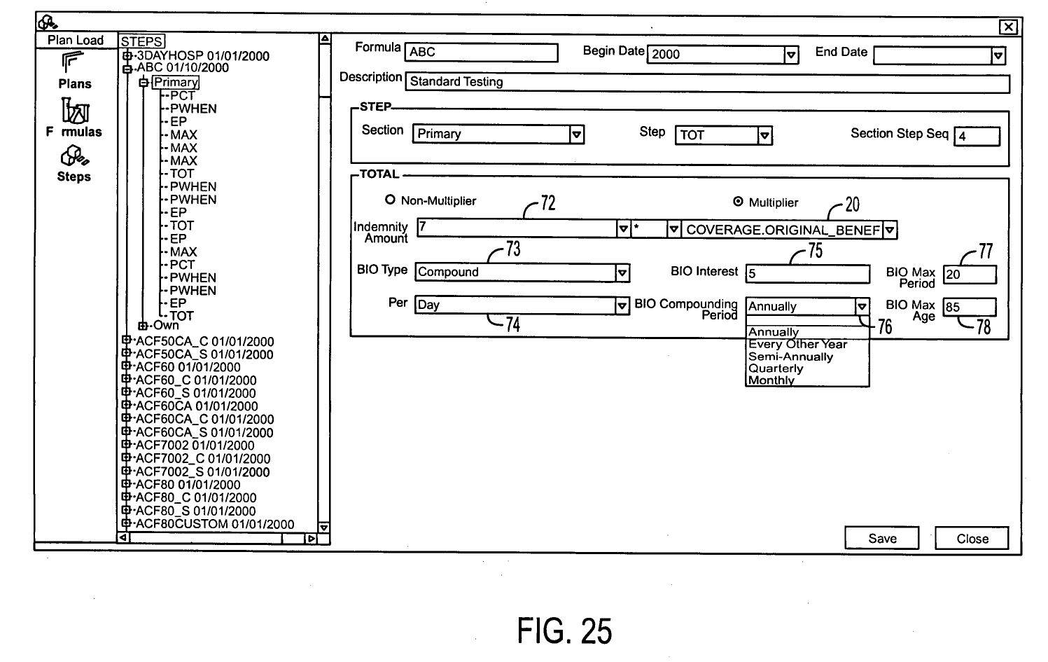

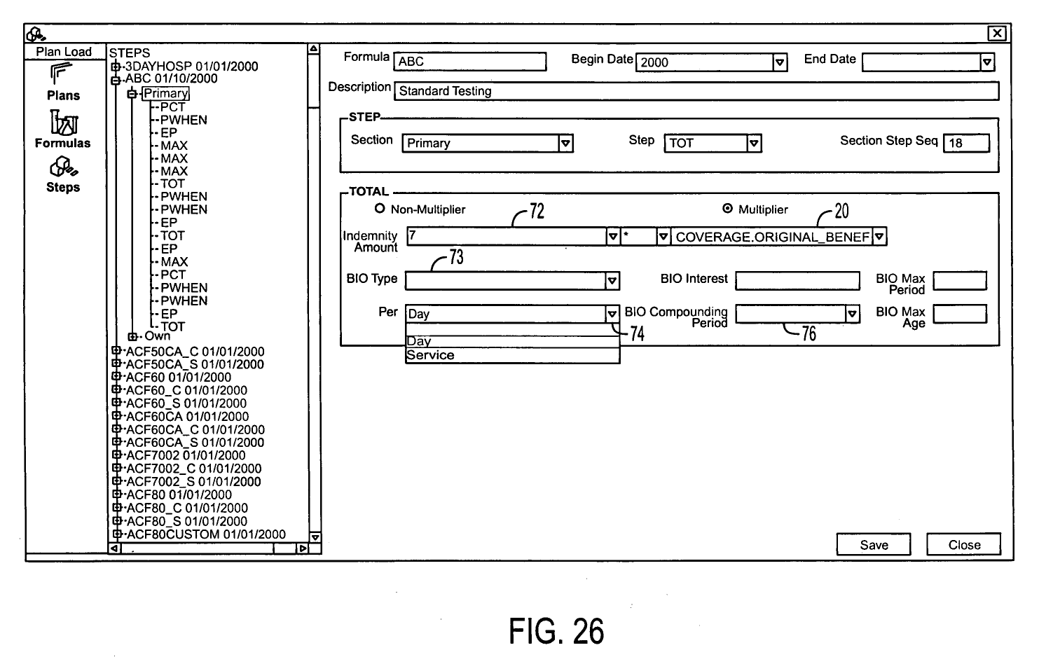

FIG. 25 illustrates the selection of the BIO compounding period 76, which can be annually, every other year, semi-annually, quarterly, or monthly. FIG. 26 shows the selection of the PER parameter 74 for the total dollar step. The PER parameter 74 can either days or service.

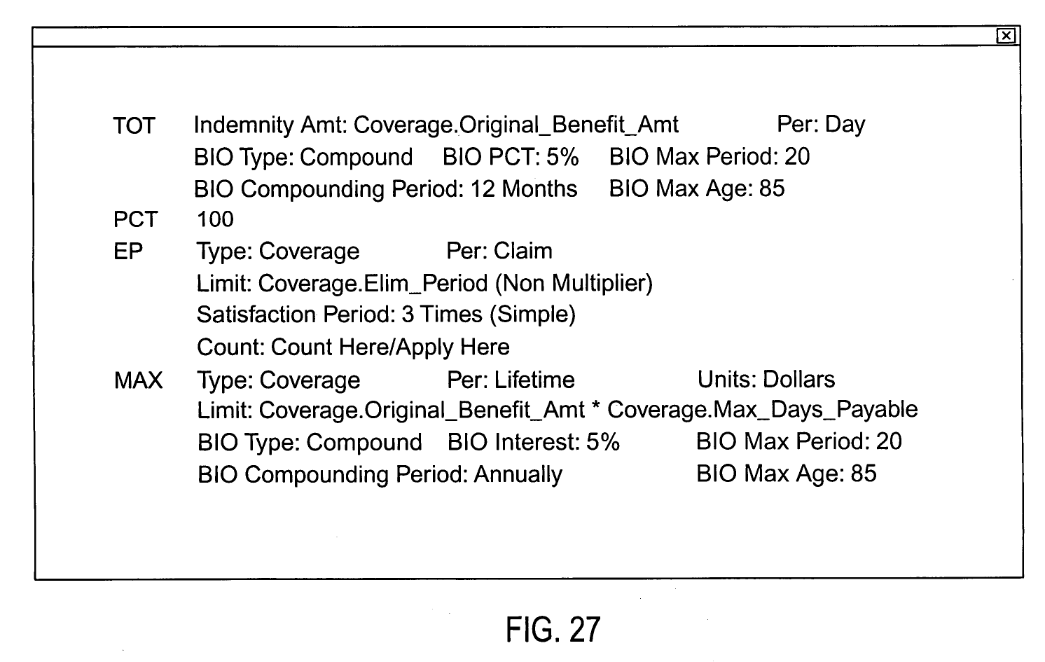

FIG. 27 illustrates a simple indemnity benefit formula. Assume that: (1) the insurance company pays a daily amount selected by the policy holder after EP is applied to each claim and for all benefits under the coverage; (2) the claimant has three times the EP limit to satisfy the EP; (3) during the policy holder's life, we pay no more than an amount equal to the maximum number of days multiplied by the daily maximum; (4) a compound BIO terminating at age 85 or after 20 years; (5) BIO is compounded annually at a rate of 5%.

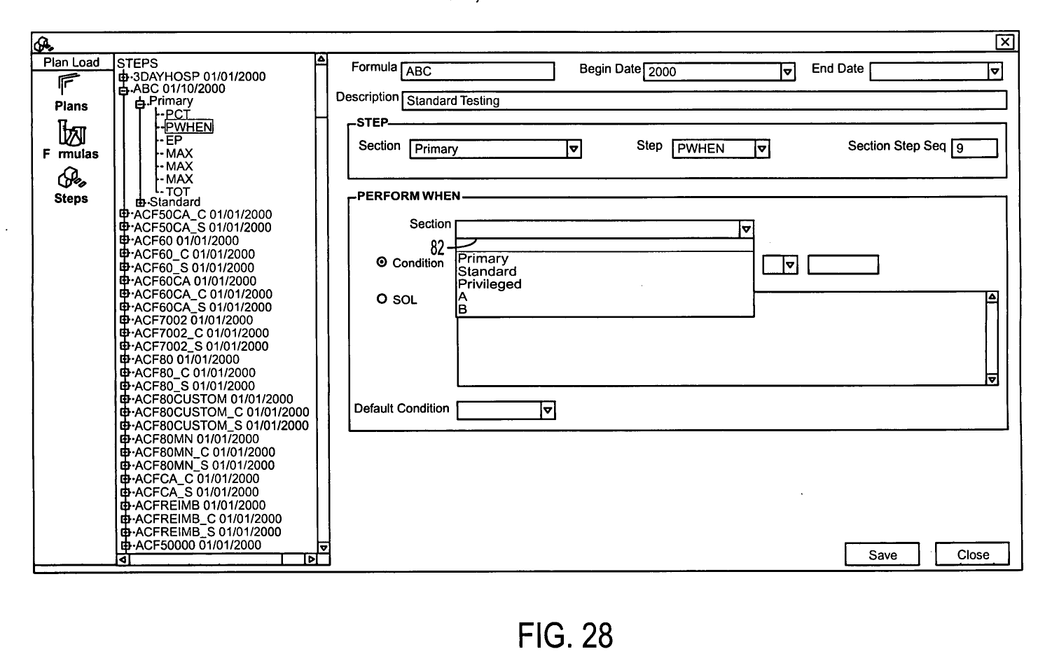

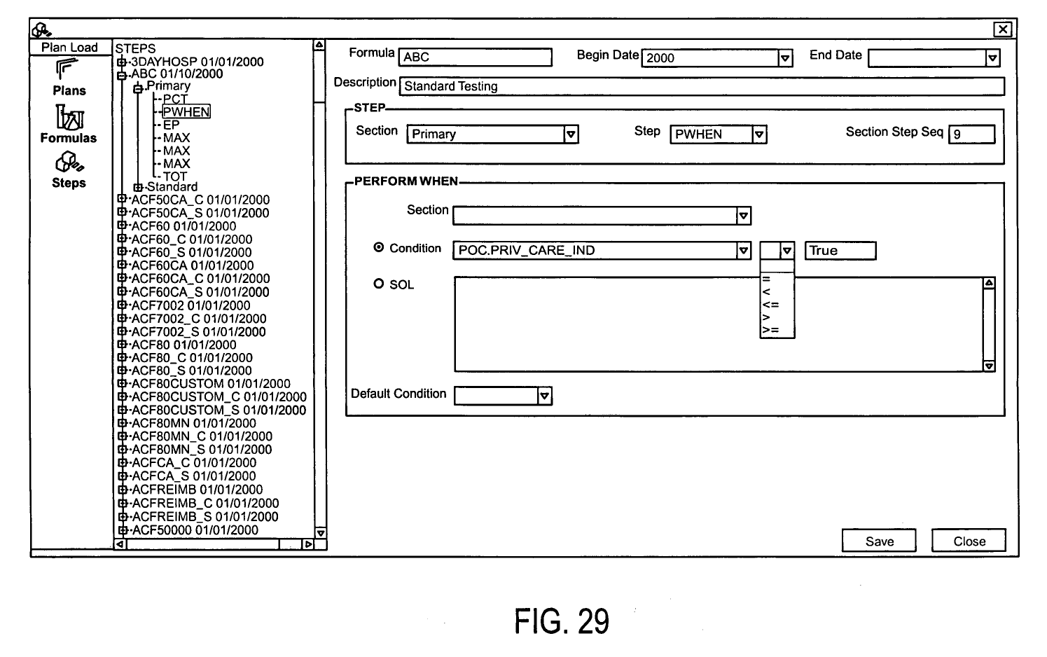

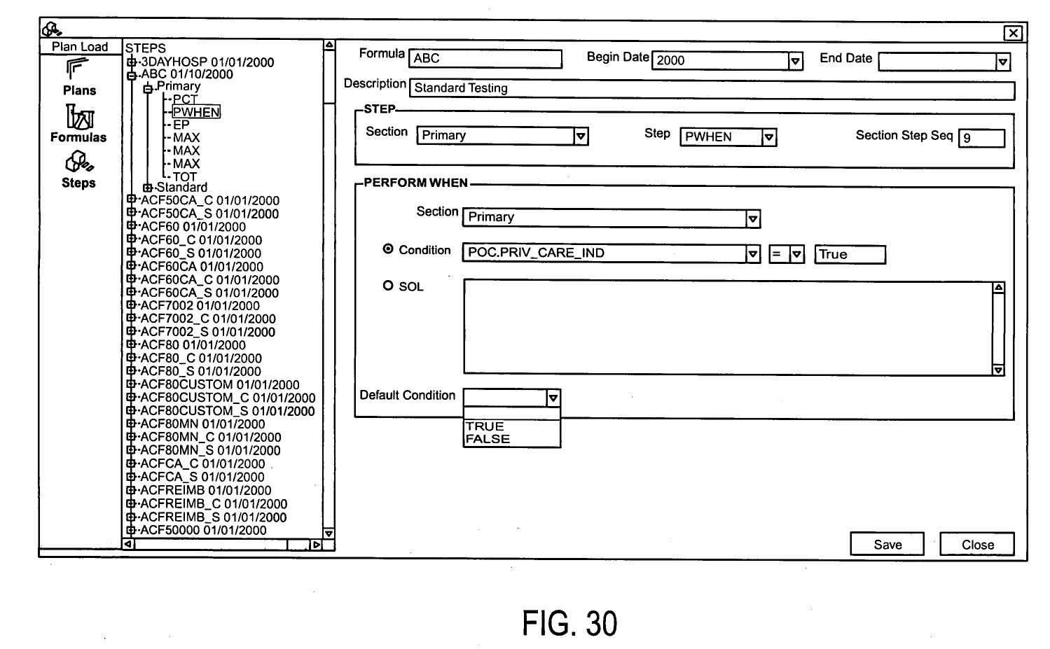

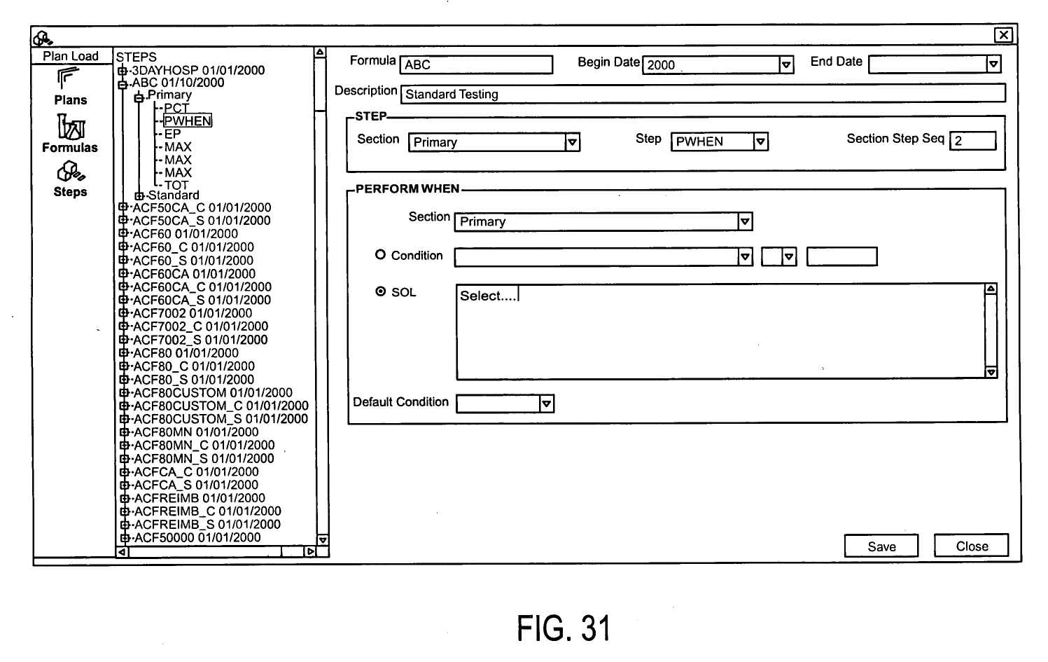

The traffic regulating step is used for contracts where an amount of payment varies according to pre-specified conditions. For example, PCS pays differently based on plan of care. If a participant uses the care coordinator provided by the insurance company rather than the participant's own care coordinator, the following changes occur: (1) the maximum is weekly rather than daily; (2) unskilled benefits are paid at 100% rather than 80%; (3) no EP must be satisfied for HHC benefits; and (4) the HHC days go toward meeting the EP for NH. Claims benefit analysts enter a plan of care type so it is available on the claims database 140 and a PCS formula can automatically calculate benefits appropriate to that plan of care. A user interface screen 80 for the traffic regulating step is shown in FIG. 28. A selection may be chosen as Primary Standard, or privileged. FIG. 29 illustrates the selection of a condition 83. FIG. 30 illustrates the selection of a default condition of True or False and FIG. 31 illustrates SQL selection 84.

The following is an example of a PCS plan using a traffic regulating step. An HMKR has the following provisions: (1) pays weekly maximum for privileged POC and daily for own POC; (2) pays benefit at 80% for own POC and 100% for privileged POC; (3) applies an EP to each claim for own POC; (4) does not require privileged POC to satisfy an EP; (5) days of HMKR go toward meeting the EP for NH; (6) claimant has three times an EP limit to satisfy EP; (7) during policyholder's life, the insurance company pays no more than an amount equal to maximum days multiplied by daily maximum dollars; and (8) compounds BIO annually at a rate of 5%.

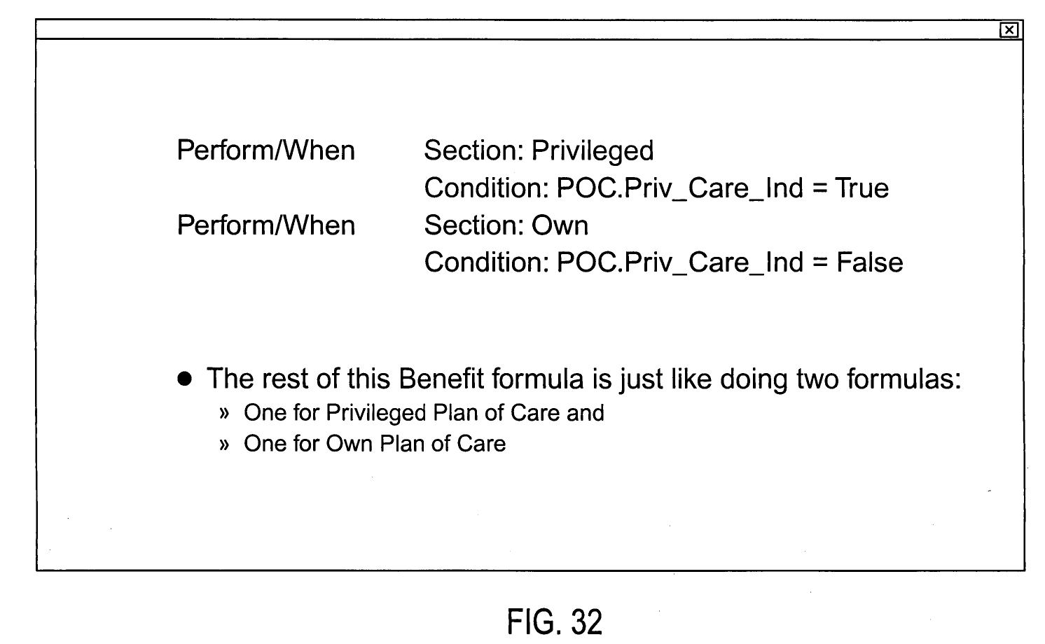

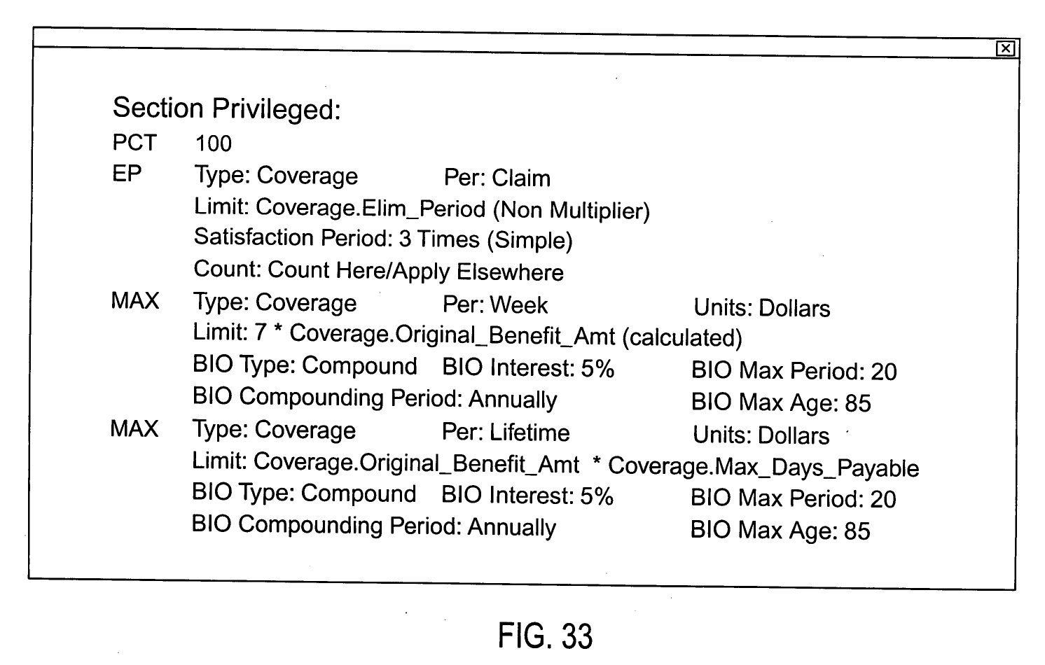

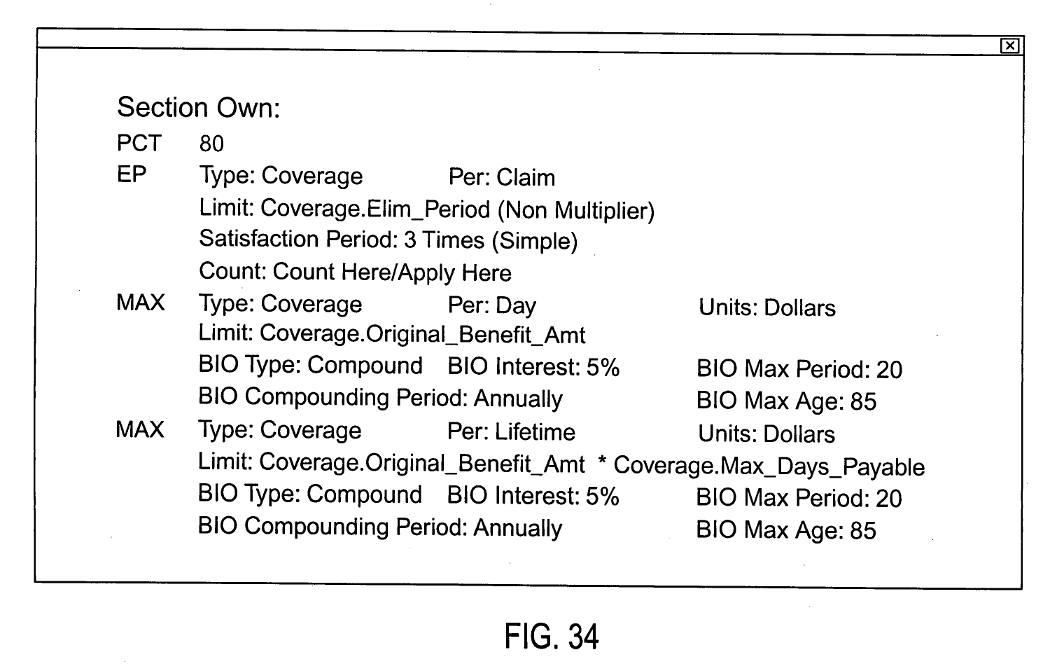

As shown in FIG. 32 formulas is provided for each section 82. As can be seen from FIGS. 33 and 34, the last steps of both sections are the same. Accordingly, it is possible to delete them and just add one lifetime MAX after both traffic regulating steps.

In summary, the new system will collect history on the nature of the claimant's disablement, handle all the complex calculations of benefits for indemnity and new reimbursement products, and provide reports and feeds for all financial and actuarial needs.

The claims management system 110 will be useful to claim adjudicators, customer service representatives, and to the actuarial, financial, medical, and legal departments. The claims management system 110 adds to the resources for long term care products and supports a “prevailing expenses” model for long term care product services. The claims system will facilitate compliance with state reporting requirements.

Overall, the claims management system 110 improves the consistency of processing, improves cycle-time of processing and improves accuracy of data captured and benefits calculated through the use of automation. Business rules have been developed and loaded into the benefits calculation engine 152. Business triggers, routing and processing workflow are driven by key business rules. Development of product models with specialized claims processing rules for each product improves service levels. Data captured for experience and profitability add knowledge to product development.

The claims management system is a client server based claim administration application. It is a database driven point and click application and includes a unique collection of information for product experience, coverage suitability, state reporting and prevailing expenses. Functions supported include pre-claim tracking and follow-up, initial claim set-up and compliance tracking, benefit calculations, ongoing claim processing, follow-up, and payments.

In order to build the above-described claims management system, development teams conduct two phases. In both phases, joint application design (JAD) sessions should preferably be used to confirm details including a preliminary JAD for the overall project. The team should prototype the changes with continual business input.

In the first phase, efficiency can be achieved by breaking work into six different builds, with each build roughly corresponding to a requirements section. Advantageously, two teams work in parallel on two builds. Initially, one team works on claim entry, while another works in parallel with adjudication. Subsequently, one team develops plan loading, while another works in parallel with payment processing. Finally, one team develops administrative tasks, while another works in parallel with reports.

In order to install the claims management system, technical experts set up oracle databases, load files with test data, adjust sign on and security for environment, change claims setup, install on remote machines, and enter test cases for verification. Other required operations include training insurance personnel, creating a data model, and performing data conversion.

Build one preferably develops claim entry, inquiry, and maintenance. Developers make additions or changes to database, interfaces to claims image and CLOAS, develop login and main menu, develop claim setup, develop client and claim inquiry, design and construct test plan, perform quality review, and test and repair.

Build 2 preferably develops the claim adjudication tools 154. The build includes additions or changes to the database 140, development of client entry, design and construction of the test plan, quality review, and test and repair.

Builds 3 and 4 include a JAD session for benefit calculation, JAD for design of plan load facility, JAD for payment processing, internal design JAD, and software training. More specifically, build 3 preferably includes development of claim management and plan loading tools 157 and the benefit calculation engine 152, such as additions or changes to database, development of the plan load facility shell, development of claims benefit and ADL edit lists, development of indemnity calculations, development of BIO calculations, development of limits, percentages and EP, development of waiver and interest charges, design and construction of test plan, quality review, and test and repair.

Build 4 preferably includes payment processing, additions or changes to the database 140, developing benefit payment processing tools 155 and expense payment and adjustment tools 156, developing an EOB facility, developing feeds used by the claim and financial reporting tools 153 including feeds to experience, DRR, polysystems and GL, and developing feeds to positive pay and check writing. Build 4 also includes design and construction of the test plan; quality review; and test and repair.

Builds 5 and 6 include JAD for TPA and administrative tasks, and JAD for reports and correspondence. Specifically, build 5 includes TPA and administrative tasks, additions or changes to the database, development of the limits authorization facility, development of the transaction log and scratch pad facilities, development of screens for entry of parameter tables, development of manager level corrections facility, design and construction of the test plan, quality review, and test and repair. Build 6 includes development of reports and correspondence including additions or changes to the database 140; reporting of claim totals, new and closed claims, and claim numbers; reporting of expenses by type and provider; providing reports required for state partnership products; producing bank report of benefit and expense payments, reporting voids, providing file of claimants, preparing year end report to clients of benefits paid and denied, reporting suspected fraud, providing ad-hoc reports, developing 1099 program for tape and letter; designing and constructing the test plan; quality review; and test and repair.

After the six builds, acceptance testing and user training should be performed. Subsequently, the development team implements the system. System implementation includes developing and performing production support overview; developing change control documentation; clearing implementation with change control; and installing the new system including CPP conversion.

Phase 2 begins with a JAD session to identify and confirm requirements for missing functionality. Just as phase 1, phase 2 includes a plurality of builds. For builds 1 and 2, this includes a JAD for claims entry, inquiry, and maintenance, and a JAD for claim adjudication and payment. More specifically, for build 1, the team performs additions and/or changes to the database; development of process modifications; design and construction of test plan; quality review; and test and repair. In build 2, the team performs claim adjudication and payment including additions or changes to the database; development of claimant confinement calls by facility; automatic request of renewal information; development of ability to group confinement calls, facility contact; development of auto-generate facility inquiry form; design and construction of test plan; quality review; and test and repair.

For builds 3 and 4, the team should have a JAD for TPA and administrative tasks and a JAD for correspondence, reports, and extracts. More specifically for build 3, the JAD for TPA and administrative tasks includes additions or changes to the database; development of process modifications; support of EDI and vendor bill reconciliation; support of EFT for benefit and expense payments; producing multiple copies of checks; design and construction of a test plan; quality review; test and repair. The JAD for build 4 for correspondence and extracts includes additions or changes to the database; development of process modifications; pending claim notification, periodic reminders; correspondence, free-form letters; other reports required for state partnership; generating acknowledgement letter to POA; generating a claim closure letter; designing and constructing a test plan; quality review; and test and repair. After the builds, acceptance testing and user training will be required.

The next step is implementation of phase II. Phase II includes preparing change control documentation and conducting review; preparing production support documentation and conducting review; and installing enhancements.

Several project control procedures will be implemented. Quality reviews will be conducted at the end of each stage based on quality criteria developed at the start of the project. A test plan will be developed based on our internal standard using testing methodology. Progress will be monitored by the Project Manager based on weekly reports.

The Project Manager will be responsible for maintaining Issue Management documentation and resolving issues with the Project Board. Problems will be documented and reported at project board meetings. The Project manager will monitor and report on risks and their impact to the project board which will decide on appropriate action.

In summary, the claims management system 110 will be able to process both indemnity and reimbursement claims by: capturing disablement information for adjudication, claims management and pricing; automating the calculation of benefits for current plans; providing a facility to load future plan calculations and eligibility; performing statutory and internal reporting and feeds to our financial systems; downloading CLOAS policyholder information to set up and administer claims; providing appropriate security for all data and transactions; automating vendor submission of disablement and plan of care information; automating reconciliation of vendor bills; and allowing claims to be paid by EFT.

Use of the system results in tangible benefits such as reduced processing costs and mainframe cost avoidance. The system also results in intangible benefits such as improved claim management through recording of disablement and plan of care history, which avoids unnecessary services and charges. A further benefit is the ability to improve pricing since added detail behind claims charges will allow the actuaries to properly attribute costs to specific plan provisions. The system improves underwriting through added detail about types of disablement that allows underwriting to develop better screening of applications.

It will be apparent to those skilled in the art that various modifications and variations can be made in the system and method of the present invention without departing from the spirit and scope of the invention. Thus, it is intended that the present invention cover the modifications and variations of this invention provided that they come within the scope of the appended claims and their equivalents.

What is claimed is:

1. An automated system for managing insurance information and processing insurance claims, the automated system residing on a host server and comprising:
means for capturing and maintaining disablement information including a network interface and a user interface for capturing the disablement information and a database for storing the disablement information; and
processing tools for processing the disablement information, the processing tools comprising a benefits calculation engine for determining benefits payable, the benefits calculation engine comprising a plurality of formulas, each formula corresponding to specific disablement information, wherein the benefits calculation engine calculates benefits for multiple reimbursement products available for multiple disablement scenarios.

2. The automated system of claim 1, wherein the processing tools further comprise benefit payment processing tools for paying benefits calculated by the benefits calculations engine.

3. The automated system of claim 1, wherein the processing tools further comprise claim management and plan loading tools for updating the benefits calculation engine.

4. The automated system of claim 1, wherein the processing tools further comprise customer service tools for collecting provider data, conducting claims inquiries, and facilitating new claims setup.

5. The automated system of claim 1, wherein the processing tools further comprise claim adjudication tools for tracking financial adjudication data.

6. The automated system of claim 1, wherein the processing tools further comprise expense payment and adjustment tools for processing reimbursement vendor bills, separating benefits from expenses, and remitting fees for multiple transactions in a single transaction.

7. The automated system of claim 6, wherein the expense payment and adjustment tools further comprise means for applying payments by claim to benefit and expense accounts.

8. The automated system of claim 6, wherein the expense payment and adjustment tools further comprise means for handling voided checks and returned checks and means for allowing benefit payments to be canceled and associated checks to be voided.

9. The automated system of claim 1, further comprising claim and financial reporting tools for performing financial reporting, claim valuation, statistical analysis, partnership reporting, bank reconciliation, and check writing.

10. The automated system of claim 1, wherein the benefits calculation engine comprises means for limiting benefit payments to coverage maximums and for calculating an elimination period in days and a deductible in dollars.

11. The automated system of claim 1, wherein the benefits calculation engine comprises means for accessing a benefit code applicable to each reimbursement product.

12. An automated system for managing insurance information and processing insurance claims, the automated system residing on a host server and comprising:
a network interface for communicating with a client over a network;
a user interface for allowing manual data entry;
a database for storing insurance data entering the system through the network interface and the user interface; and
processing tools for processing the insurance data, the processing tools comprising,
customer service tools including claim display means for displaying claim data, data maintenance means, correspondence tools for generating letters, and tracking means for tracking policyholders and claimants;
claim adjudication tools including means for tracking claimant data, means for tracking plans of care, means for tracking historical data by claim, and means for tracking final adjudication data;
a benefits calculation engine for automatically calculating benefits payable;
benefit payment processing tools including means for minimizing key entry, means for automating reimbursement claims, and means for calculating interest amounts;
expense payment processing and adjustment tools including means for processing reimbursement vendor bills, means for reconciling vendor bills with services performed, means for applying payments by claim to benefit and expense accounts, means for producing expense reports, and means for allowing changes to payments;
claim reporting tools for performing financial reporting, valuation, statistical analysis, partnership reporting, and experience analysis; and
claim management and plan loading tools including means for instructing the system in order to properly operate the benefits calculation engine, the claim management and plan loading tools including means for identifying a plan, its coverages, and coverage limits.

13. The automated system of claim 12, wherein the processing engine includes means for limiting benefit payments to a coverage maximum.

14. The automated system of claim 12, wherein the benefits calculation engine accesses a benefit code for each product to determine an appropriate formula.

15. The automated system of claim 12, wherein the benefits calculation engine includes formulas having calculation steps and traffic regulating steps.

16. The automated system of claim 15, wherein the calculation steps comprise a total dollars step; a maximum step; and an elimination period step.

17. The automated system of claim 15, wherein the traffic regulating step comprises four parameters including a true/false condition; a next step; a default condition; and an SQL expression.

18. The automated system of claim 12, wherein the customer service tools further comprise means for setting up new customer claims.

19. The automated system of claim 12, wherein the benefit payment processing tools further comprise means for making payments to insured, beneficiaries, vendors, and others.

20. The automated system of claim 12, wherein the claim management and plan loading tools further comprise means for receiving instructions from a user for calculating benefits.

21. A method for reducing the manual effort involved in insurance claims payment, benefits calculation, and vendor bill calculation, the method comprising using an automated system for performing the steps of:
capturing disablement information for adjudication, claims management, and pricing;
performing automated benefits calculation for existing plans with a benefits calculation engine;
providing means for loading future plan calculations and eligibility;
performing statutory and internal reporting and feeds; and
downloading policyholder information to set up and administer claims.

22. The method of claim 21, further comprising the step of paying a benefit amount calculated by the benefits calculations engine using benefit payment processing tools.

23. The method of claim 22, wherein the step of providing means for loading future plan calculations and eligibility comprises receiving updated calculation information with claim management and plan loading tools.

24. The method of claim 23, wherein the step of capturing disablement information comprises using customer service tools for collecting data.

25. The method of claim 21, further comprising the step of tracking financial adjudication data using claim adjudication tools.

26. The method of claim 21, further comprising the step of using expense payment and adjustment tools for processing reimbursement vendor bills, separating benefits from expenses, and remitting fees for multiple transactions in a single transaction.

27. The method of claim 21, wherein the step of performing automated benefits calculation comprises limiting benefit payments to coverage maximums and calculating an elimination period and a deductible.

28. The method of claim 21, further comprising the step of accessing a benefit code in order to select an appropriate reimbursement formula.

29. The method of claim 28, further comprising the step of using formula having calculation steps and traffic regulating steps in order to calculate benefits.

30. A method for automatically processing a request for insurance benefits, the method comprising:
receiving a benefit request;
accessing captured disablement information to determine an appropriate benefit;
searching for a formula that corresponds to the appropriate benefit, each formula including at least one calculation step selected from a total dollars step that generates an amount for indemnity benefits, a MAX step that limits an amount payable to a maximum, an EP step that requires an elimination period to be met prior to payment, and a PCT step that pays a fixed percentage of remaining funds;
modifying an existing formula to correspond to an appropriate benefit if the appropriate benefit has no corresponding formula; and
using the corresponding formula to calculate a benefit.

31. The method of claim 30, wherein the step of accessing captured disablement information includes accessing claimant services information, assessment data, plans of care, care management costs, losses by activities of daily living, and eligible facilities.

32. The method of claim 30, wherein the step of searching for a formula further includes searching for a formula having a traffic regulating step, each traffic regulating step having four parameters including a condition, a next step, a default step, and on SQL expression.

33. The method of claim 30, further comprises the step of paying the calculated benefit using benefit payment processing tools.

34. The method of claim 30, further comprising the step of performing financial reporting with claim reporting tools.

35. The method of claim 30, further comprising the step of tracking financial adjudication data using claim adjudication tools.

36. The method of claim 30, further comprising the step of capturing disablement information using customer service tools.
